(19) United States
(12) Patent Application Publication
(10) Pub. No.: US 2025/0090995 A1
(43) Pub. Date: Mar. 20, 2025

(54) ELECTROMAGNETIC REGENERATION OF IONIC LIQUIDS POST CO2 CAPTURE

(71) Applicants: Case Western Reserve University, Cleveland, OH (US); Oak Ridge National Laboratory, Oak Ridge, TN (US)

(72) Inventors: Burcu Gurkan, Shaker Heights, OH (US); Michelle Kidder, Clinton, TN (US); Aidan Klemm, Cleveland, OH (US)

(21) Appl. No.: 18/662,547

(22) Filed: May 13, 2024

Related U.S. Application Data
(60) Provisional application No. 63/501,832, filed on May 12, 2023.

(51) Int. Cl. B01D 53/14

(52) U.S. Cl. CPC B01D 53/1425; B01D 53/1475; B01D 53/1493; B01D 2252/30; B01D 2257/504

(57) ABSTRACT

A method of regenerating an ionic CO₂ capture material saturated with CO₂ includes applying an electromagnetic field to the ionic CO₂ capture material at a frequency and intensity effective for dielectric heating of the ionic CO₂ capture material and desorption of captured CO₂.

### RELATED APPLICATION

This application claims priority from U.S. Provisional Application No. 63/501,832, filed May 12, 2023, the subject matter of which is incorporated herein by reference in its entirety.

### GOVERNMENT FUNDING

This invention was made with government support under DE-SC0022214 awarded by the National Science Foundation. The government has certain rights in the invention.

### BACKGROUND

Ionic liquids (ILs) are salts that are commonly liquid under ambient conditions. Made mostly of bulky organic ions, ILs have almost infinite structural and chemical tunability. They are often referred to as “green solvents” or “designer solvents” for their intrinsic physiochemical properties, such as negligible volatility, non-flammability, good thermal stability, as well as wide electrochemical window. ILs demonstrate unique features for a broad spectrum of applications, such as media for synthesis, electrolytes, lubricants, as well as gas separations. Specifically, the low volatility and high CO₂ solubility of ILs are appealing in CO₂ separations. CO₂ occupies the intrinsic entropic voids of ILs via the distinctive interactions between the quadrupolar CO₂ and polar ions. Furthermore, ILs can be functionalized with nucleophilic functionalities that chemically bind with CO₂. IL based sorbents, with amine, strong base, and multiple site cooperative interactions, have been extensively studied for post combustion carbon capture and more recently considered for direct air capture (DAC). The distinct environmental difference in DAC from post combustion capture is the presence of significant amount of O₂ in air. Thermal and oxidative stability is important for the longevity and recyclability of materials for DAC and the behavior of ILs is not well known, particularly those that are being developed for DAC.

In addition to the importance of thermal and oxidative stability, regenerability with precise energy regulation and with external stimuli are of interest for CO₂ capture sorbents. Regeneration of sorbents has traditionally relied on temperature-swing operations and the availability of thermal energy to desorb the CO₂ and recycle the sorbent. Recently, bottom-up approaches involving metal-ion coordinated amines as reactive CO₂ capture agents are demonstrated to lower the energy requirement and increase sorbent stability for regeneration. With the increasing availability of renewable energy sources, alternative regeneration approaches that do not rely on thermal energy from fossil-fuel burning is gaining interest. There have been few reports on the microwave-based regeneration of conventional aqueous amines and solid sorbents. However, it is not known whether ILs are susceptible to this emerging regeneration approach. Recognizing that electromagnetic field has heating effects that originate from conduction and dielectric polarization phenomena, we postulate that ILs with high concentrations of charged species would be ideal liquid candidates for dielectric heating. Highly polar materials are susceptible to dielectric heating as the alternating electric field at MW frequency range causes the dipoles to reorient in an oscillatory fashion, the friction of which generates heat. Furthermore, it is expected that the energy would be more intense and targeted than direct thermal heating for the CO₂-rich domains of functionalized ILs since CO₂-bound species are ionic (i.e., carbamate, carboxylate, carbonate).

### BRIEF DESCRIPTION OF THE DRAWINGS

FIGS. 1(A-B) illustrate (A) ESI-MS for Sample 4. The top two scans are the positive scans and the bottom two are the negative scans. Solvent blank; sample. Note that some of the impurities from the solvent also appear in the sample spectra due to pre-contamination of the ESI-MS chamber. The peaks highlighted in yellow are the cation and anion of [EMIM][2-CNpyr]. The spectra for Sample 1 is shown in FIG. 13. (B) Molecular structure of EMIM⁺ and 2-CNpyr⁻ of the IL (in yellow) and the degradation components (in orange) detected by ESI-MS: cation (I); anion (II); oxidized cation (III); oxidized anion (IV); anion dimer (V). The peak intensities in the negative scans were normalized by that of 2-CNpyr⁻.

FIGS. 2(A-B) illustrate (A) Gas chromatograms of the off-gas from the degrading experiments of Sample 4 at day 1 (left panel) and day 7 (right panel). FID1 shows no volatile organics. TCD1 (mobile phase: He) shows CO₂ peak after long exposure to O₂. TCD2 (mobile phase: N₂) shows H₂ peak. The artificial peaks, labeled with *, are originated from the pressure deviation within the GC column due to pneumatically controlled valve events. (B) Gas chromatography of the off-gas from Sample 4 with data collected in 6 h-intervals from all three detectors. The presence of CO₂ peak was highlighted with grey background.

FIG. 3(A-B) illustrate (A)¹³C-NMR of the fresh IL and the degraded IL samples showing only 102-132 ppm region. The cation splitting and shifting for CO₂ binding was highlighted in grey and the anion dimer is highlighted in orange. The spectra of CO₂ absorbed IL from the absorption experiments under 410 ppm CO₂ (in khaki color) we reported previously is included as a point of reference. The symbol “t” marks the peaks of an unidentifiable decomposed component that has very low concentration. The full ¹³C-NMR spectra are given in FIG. 14. (B) The labeling of the NMR peaks. The protons on IL are labeled with (a, b, c, . . . ), the CO₂ bound products with (a′, b′, c′ . . . ), and the anion dimer with (1, 2, 3, . . . ).

FIG. 4 illustrates FTIR spectra of the fresh IL and degraded IL (Samples 1 to 4). Regions highlighted in grey are the absorption peak shifts due to CO₂ binding. Region highlighted in orange indicates the strong C≡N stretch of the oxidized cyano group and possibly the anion dimer. Regions highlighted in green are potential formation of secondary amines (3330 cm⁻¹), hydroxyl (3300 cm⁻¹), and alkenyl groups (3090 cm⁻¹ and 1620 cm⁻¹), that are not detected with the previously discussed methods, however their presence support the proposed mechanism of CO₂ evolution. The full FTIR spectra are given in FIG. 15.

FIGS. 5(A-B) illustrate proposed mechanisms of oxidative and thermal decomposition of [EMIM][2-CNpyr]under continued exposure to O₂ and heat (80° C. for 7 days). The oxidation derived compounds of EMIM⁺ and 2-CNpyr⁻ further produce CO₂ and H₂ as detected by GC.

FIGS. 6(A-B) illustrate (A) TGA of samples in Table 2 with heating to 600° C. under N₂ at 10° C./min. (B) The first derivative of TGA weight loss against the heating temperature. The thermogram plotted as a dashed line represents the decomposition of [EMIM][2-CNpyr]under air, where a slightly different degrading pattern is observed, notably the higher char yield.

FIGS. 7(A-B) illustrates (A) The self-diffusivity of cation (close symbols) and anion (open symbols) of [EMIM][2-CNpyr] measured via ¹H DOSY NMR. The D⁺ and D⁻ of Sample 4 closely overlapped one another. (B) Breakdown of CO₂ capacity based on the quantified ¹³C-NMR peaks of carbamate (CO₂-anion complex), carboxylate (CO₂-cation complex), and bicarbonate (CO₂-water) for the fresh IL (black outlined bars), Sample 1 (red outlined bars) and Sample 4 (blue outlined bars). The uncertainty of the breakdown capacity is calculated from the signal to noise ratio to be less than 0.05 mole CO2/kg sorbent.

FIGS. 8(A-C) illustrate CO₂ breakthrough curves (A), CO₂ absorption/desorption rate (B), and regeneration efficiency (C) for [EMIM][2-CNpyr] for two consecutive cycles. Absorption at 25° C. with both 0% RH (dotted lines) and 50% RH (solid lines) feed gas (5000 ppm CO₂ in 80/20 N₂/O₂). MW based desorption at 100° C. in 1^{st} cycle and 80° C. in 2^{nd} cycle. Regeneration efficiency is defined as the ratio of the amount of CO₂ desorbed per CO₂ absorbed. Sample was pretreated by dielectric heating at 50° C. for 4 hrs. The microwave (2.45 GHz) power was automatically controlled between 1-10 W for the set desorption temperatures; power and temperature profiles for the 2^{nd} cycle (0% RH) are shown in FIG. 19 as an example.

FIG. 9 illustrates working capacity (bars) of [EMIM][2-CNpyr]during 8 cycles (16 hrs total) of absorption (25° C.) under 5000 ppm CO₂ and desorption at 80° C. under N₂; comparing the convectional heating and dielectric heating by MW for regeneration. The regeneration efficiency (squares) is calculated by dividing the amount of CO₂ released by the amount of CO₂ absorbed during a given cycle.

FIGS. 10(A-B) illustrate (A)¹H-NMR and (B) HSQC spectra of [EMIM][2-CNpyr].

FIG. 11 illustrates density of fresh IL and degraded samples with respect to temperature. The solid lines Fare connecting the data points to guide the eyes. Inset photo shows the physical samples.

FIG. 12 illustrates viscosity of fresh IL and degraded IL samples. The solid lines are the Vogel-Fulcher-Tamman (VFT) fits to the viscosity data.

FIGS. 13(A-B) illustrate (A) MS spectra of the direct infusion of Sample 1. The bottom shows the positive scans for cations, and the top panel shows the negative scans for anions. The highlight sin yellow show the cation and anion peaks of [EMIM][2-CNpyr]. (B) Molecular structure of [EMIM]+ and [2-CNpyr]⁻ of the IL (in yellow) and their degradation compounds (in orange). The tabulated peak intensity in the negative scan was normalized by that of [2-CNpyr]⁻. The orange highlights in panel a correspond to the m/z of the degraded components. The small peaks labeled with are the common background contamination of acetonitrile clusters (124.08; [M+proton]⁺) and acetonitrile/acetic acid (119.08; [M+CH₃COOH]⁺).

FIGS. 14(A-B) illustrate (A) Quantitative ¹³C-NMR of neat [EMIM][2-CNpyr] and degraded ILs. For comparison the spectra of [EMIM][2-CNpyr] with anhydrous feed of 410 ppm CO₂ in N₂ was shown in khaki color as reference. (B) Molecular structure of anion dimer (top), [EMIM][2-CNpyr]bonded with CO₂ on cation and anion (middle), and [EMIM][2-CNpy]itself (bottom).

FIG. 15 illustrates ATR-FTIR spectra of fresh [EMIM][2-CNpyr] and degraded IL samples. Fresh IL upon exposure to N₂ with 410 ppm CO₂ (yellow spectra) is shown as a reference.

FIGS. 16(A-B) illustrate ¹H-NMR (A) and HSQC (B) spectra of [EMIM][Pyr]. Fragments of alkyl carbon chain around 1-4 ppm are present possibly from the degradation of cation by the nucleophilic attack of the anion.

FIG. 17 illustrate the ¹H PFG NMR spectra of fresh [EMIM][2-CNpyr]. Notice that the chemical shifts of a DOSY NMR may be different from regular ¹H-NMR for the IL since the IL sample in this case was separated from the d-solvent (which is in an inner compartment) so as to not affect the viscosity of the sample and the ion solvation state.

FIG. 18 illustrates Photo (left) and the schematics (right) of the microwave chamber for CO₂ breakthrough measurements. A CEM Discover 2.0 Microwave Synthesizer was adapted to house the sample container (125 mL flat-bottom Pyrex glass flask) that is directly connected to feed gas and the exhaust lines. The exhaust line is connected to the IR gas analyzer (SBA-5, PPSystems Inc.) to quantify the CO₂. Vacuum pump is connected to evacuate the sample chamber prior to the measurements. The feed gas was prepared by mixing the desired amount of CO₂ and synthetic air (80/20 N₂/O₂) using the mass flow controllers (MFCs) via LabVIEW and held at the gas reservoir prior to feeding to the sample container in the microwave chamber. The IR sensor for monitoring the liquid sample temperature is not shown explicitly. Also not shown is the humidifier downstream of the feed gas holding cell for 50% RH feed experiments.

FIG. 19 illustrates microwave power and temperature profiles as a function of time (representing the 2^{nd} regeneration cycle in FIG. 8).

FIGS. 20(A-B) illustrate quantitative ¹³C-NMR of [EMIM][2-CNpyr]after CO₂ absorption at 25° C. (top panels) and MW regeneration at 100° C. (bottom panels) for the 1^{st} desorption (A) and the 2^{nd} desorption (B).

FIG. 21 ¹H-NMR of [EMIM][2-CNpyr]after MW regeneration at 100° C. for 1 hour.

FIG. 22 illustrate ATR-FTIR of [EMIM][2-CNpyr]before and after CO₂ absorption and after MW regeneration at 100° C. and 80° C.

FIG. 23 illustrates ¹H-NMR of [EMIM][2-CNpyr]after 8 thermal (top) and 8 MW (bottom) cycles, respectively.

FIG. 24 illustrates schematics of the membrane test unit. Permeate gas was collected and sent to gas chromatogram (GC) either by the sweep (path \textcircled{1}) or by vacuum (path \textcircled{2}) for a transmembrane pressure of 0 or 1 atm, respectively. The balance gas of CO₂ is either synthetic air (N₂/O₂=80/20) or N₂ for the CO2/N₂/O₂/H₂O or CO₂/N₂/H₂O mixtures, respectively.

FIGS. 25(A-B) illustrate (A) Measured CO₂ capacity of [EMIM][2-CNpyr] at 22° C. and 40% RH (10.6 mbar) by quantitative ¹³C-NMR with and without (red bordered bars) O₂ in the synthetic air feed. The O₂ concentration in the gas mixtures was maintained at about 20% with the exception of 200 000 ppm CO₂ where O₂ concentration was 16%. The uncertainty in the reported capacities is calculated from the signal to noise ratio and found to be less than 0.05 mole CO₂ per kg sorbent. (B) The dependence of self-diffusivities of [EMIM]⁺ (filled symbol) and [2-CNpyr]⁻ (hollowed symbol) on the CO₂ concentration in the absorbed feed gas with (red) and without (gray) O₂.

FIG. 26 illustrates the phase diagram of PIL IL mixture (in molar ratio) measured by DSC, with a scanning rate of 10° C. min⁻¹ under N₂. The glass transition (T_{g}) points are connected with red dashed line as the hypothetical trend of phase-transition of the gel from the glassy state to elastomeric state. The plot of DSC curve from which T_{g} was obtained is given in FIG. 38.

FIGS. 27(A-D) illustrate schematics and the cross-sectional SEM images of UF substrate (A), the fabricated bPES/PET substrate (B), GONF on bPES/PET substrate (C), and PIL-IL/GO selective layer on bPES/PET substrate (D). The zoomed-in images on the right for (A) and (B) panels show the difference in porosity of the PES skin layer. The surface morphology shown on the right of panels (C) and (D) represent the GONF top surface before and after impregnation with PIL-IL gel, respectively. The surface morphology of the unmodified UF and bPES/PET substrates are shown in FIG. 39A.

FIG. 28 illustrates FTIR spectra of PIL, IL, PIL-IL, PIL-IL/GO on bPES/PET, GONF on bPES/PET, and bPES/PET substrate. The vertical dashed lines mark the resonance peak of v_{OH} 3430 cm⁻¹ (GONF), v_{aromatic-CH} 3100 cm⁻¹ (IL), v_{alkyl-CH} 2900 cm⁻¹ (PIL), v_{C≡N} 2220 cm⁻¹ (PIL and IL), v_{C(C═O)} 1720 cm⁻¹ (GONF), v_{C═C} 1570 cm⁻¹ (GONF). The arrows indicate the red and blue shift-direction of each vibration in the PIL-IL/GO, due to molecular interactions among the constituents.

FIGS. 29(A-B) illustrate (A) HMBC spectra showing the molecular interactions between PIL, IL, and GO components. Inset shows the images of PIL-IL/GO material collected by scraping off the top selective layer from the PIL-IL/GO on bPES/PET to redisperse in DMSO-d₆ for HMBC NMR. (B)¹H-NMR of the PIL-IL/GO and PIL-IL gel. The GO peaks, from high field to down field, are likely due to the native alkyl-CH (˜3 ppm), OH (4.7 ppm), aromatic-CH (˜7 ppm) functionalities that are captured due to their interaction with the IL. The NMR of pure GO is shown in FIG. 40.

FIGS. 30(A-C) illustrate (A) Permeance of PIL-IL/GO on bPES/PET (i in Table 2) under CO₂/N₂/H₂O (filled circle) and CO₂/N₂/O₂/H₂O (hollowed circle). (B) CO₂/N₂ and CO₂/O₂ selectivities. (C) CO₂/(N₂+O₂) separation ratio. Notice that for CO₂/N₂/H₂O feed, the CO₂/(N₂+O₂) separation ratio is the same as CO₂/N₂ selectivity. The feed gas had a humidity level of 40% RH at 22° C.; 10.6 mbar moisture.

FIGS. 31(A-D) illustrate the change in CO₂ separation performance with humidity (A), temperature (B), membrane thickness (C), and time (D). Membrane ii (in Table 2) is used in panel (A), (B), and (D); and membrane ii, iii, and iv are used in panel (C).

FIG. 32 illustrates performance of vacuum operation of PIL-IL/GO on bPES/PET (v in Table 1) under 410 ppm CO₂ with mixture feed of CO₂/N₂/O₂ at 22 and 40° C.; both with 40% RH.

FIGS. 33(A-B) illustrate (A) ¹H-NMR and (B) HSQC of the synthesized [EMIM][2-CNpyr].

FIGS. 34(A-B) illustrates (A) ¹H-NMR and (B) HSQC of the synthesized P[DADMA][2-CNpyr].

FIGS. 35(A-C) illustrate (A) The schematics of the pulse sequence for ¹H-DOSY NMR. The first step excites the spins using a 90° radio frequency (RF) pulse. A gradient pulse of intensity g(z) and duration δ is applied, the molecules are let to diffuse during the drifting time interval Δ, and an effective opposite gradient pule rephases the spins. (B) Right: The ¹H-NMR recorded as a function of the gradient strength g(z) showing different attenuation rates for hydrogens. Left: The exponential attenuation of hydrogens at different chemical shifts plotted against the gradient step with increasing strength. The self-diffusivity (D) was calculated by equation 1 using MestReNova. An example of the ¹H-DOSY spectra is given in FIG. 36. (C) The actual pulse sequence used for ¹H-DOSY.

FIGS. 36(A-B) illustrates (A) Example ¹H-NMR spectra of neat [EMIM][2-CNpyr], with the pulse gradient strength from 2% to 95% showing the attenuation of magnetization. (B) The calculated ¹H-DOSY spectra of [EMIM][2-CNpyr]. Note that there is no deuterated solvent in the characterized samples in these measurements; solvent is separated by an inner tube as illustrated in FIG. 35A.

FIGS. 37(A-B) illustrate (A) Viscosity and (B) water content of [EMIM][2-CNpyr] as a function of CO₂ concentration and the humidity content in the gas (CO₂/N₂/H₂O) exposed to the IL. The viscosity of [EMIM][2-CNpyr]under RH 40% and 16-20% O₂ is plotted in red square symbols; very similar to the data in the absence of O₂.

FIG. 38 illustrates DSC curves of PIL-IL, with a scanning rate of 10° C./min under N₂. The glass transition temperatures are marked with an arrow.

FIGS. 39(A-B) illustrate (A) SEM images of PIL-IL/GO and GONF on the two substrates studied. Bottom images show the visual appearances of the membranes as labeled. (B) FTIR spectra comparing the PIL-IL/GO and GONF on the two substrates. The PIL-IL/GO on UF corresponds to i in Table 2, whereas the PIL-IL/GO on bPES/PET corresponds to ii.

FIGS. 40(A-C) illustrate (A) ¹H-NMR, (B) HSQC, and (C) HMBC of GO in DMSO-d₆.

FIGS. 41(A-C) illustrate (A) Permeance of PIL-IL/GO on bPES/PET and PIL-IL/GO on UF (i and ii in Table 2) under CO₂/N₂/H₂O (filled symbol) and CO₂/N₂/02/H₂O (hollowed symbol). (B) CO₂/N₂ and CO₂/O₂ selectivities. (C) CO₂/(N₂+O₂) separation ratio. Notice that for CO₂/N₂/H₂O, the CO₂/(N₂+O₂) separation ratio is the same as their CO₂/N₂ selectivity. All of the mixtures have a humidity level of 40% RH at 22° C.; 10.6 mbar moisture.

FIG. 42 illustrates CO₂ permanence PIL-IL/GO on bPES/PET (red data points) and PIL-IL/GO on UF (gray data points) under CO₂/N₂/H₂O (filled symbols) and CO₂/N₂/O₂/H₂O (hollow symbols) at 22° C.; RH 40%; 10.6 mbar moisture. The solid and dashed lines are the best fits of the data based on equation 6. The fitted parameters are listed in the inset table. The η value is related to the diffusion and reaction equilibrium of IL-CO₂ complex. The lower the diffusion and higher the equilibrium constant, the higher the value of η is. The p*value describes the condition where CO₂ transport is hindered due to carrier saturation in a kinetically controlled mass transfer process.

FIG. 43 illustrates the dependence of self-diffusivities of [EMIM]⁺ (filled symbol) and [2-CNpyr]-(hollowed symbol) on the humidity content.

### DETAILED DESCRIPTION

Embodiments described herein relate to ionic CO₂ capture materials, their use as direct air capture materials, and methods and systems of regenerating the CO₂ capture materials. The ionic CO₂ capture material can include at least one of an ionic liquid, deep eutectic solvent, or nano organic hybrid material.

In some embodiments a method of regenerating an ionic CO₂ capture material saturated with CO₂ can include applying an electromagnetic field to the ionic CO₂ capture material at a frequency and intensity effective for dielectric heating of the ionic CO₂ capture material and desorption of captured CO₂.

In some embodiments, the ionic CO₂ capture material can be dielectrically heated to a temperature effective to the desorb CO₂ without causing degradation of the CO₂ capture material. For example, the CO₂ capture material is dielectrically heated to a temperature of about 80° C. to about 100° C. without causing degradation of the CO₂ capture material.

In some embodiments, the CO₂ capture material can include an imidazolium and/or pyrrole based ionic liquid, for example, an imidazolium cyanopyrrolide ionic liquid.

In some embodiments, microwave or radio frequency energy can be applied to the CO₂ capture material at an intensity of up to about 60 watts and a frequency from about 100 kHz to about 2.45 GHz.

In some embodiments, the electromagnetic field can be applied to the ionic CO₂ capture material in atmosphere substantially devoid of CO₂ and less than about 20%, less than about 10%, less than about 5%, or less that about 1% relative humidity.

In other embodiments, the CO₂ capture material can include a facilitated transport membrane that includes an ionic liquid. For example, the facilitated transport membrane includes a thin film composite membrane embedded with a functionalized ionic liquid and poly(ionic liquid). The thin film composite substrate can include a graphite reinforced permeable bicontinuous structured poly(ethersulfone/poly(ethylene terephthalate) substrate.

Other embodiments described herein relate to a system for regenerating a direct air capture (DAC) material saturated with CO₂. The system can include a device for applying an electromagnetic field to a direct capture material at a frequency and intensity effective for dielectric heating of the direct capture material and desorption of captured CO₂. The DAC material can include at least one of an ionic liquid, deep eutectic solvent, or nano organic hybrid material.

In some embodiments, the DAC material is configured to be dielectrically heated to a temperature effective to the desorb CO₂ without causing degradation of the DAC. For example, the DAC material can be configured to be dielectrically heated to a temperature of about 80° C. to about 100° C. without degradation.

In some embodiments, the DAC material includes an imidazolium and/or pyrrole based ionic liquid, such as an imidazolium cyanopyrrolide ionic liquid.

In other embodiments, the device can include a microwave wave or radiofrequency emitter configured to apply electromagnetic energy at an intensity of up to about 60 watts and at a frequency from about 100 kHz to about 2.45 GHz.

In some embodiments, the device can include a chamber in which the DAC material is disposed for application of the electromagnetic field. The chamber can have an atmosphere substantially devoid of CO₂ and less than about 20%, less than about 10%, less than about 5%, or less that about 1% relative humidity during application of the electromagnetic field.

In some embodiments, the CO₂ capture material can include a facilitated transport membrane that includes an ionic liquid. For example, the facilitated transport membrane can include a thin film composite membrane embedded with a functionalized ionic liquid and poly(ionic liquid). The thin film composite substrate can include a graphite reinforced permeable bicontinuous structured poly(ethersulfone/poly(ethylene terephthalate) substrate.

Other embodiments described herein relate to a facilitated transport membrane for CO₂ capture. The facilitated transport membrane includes a graphite reinforced permeable bicontinuous structured poly(ethersulfone/poly(ethylene terephthalate) substrate embedded with a mixture of a functionalized ionic liquid and poly(ionic liquid).

In some embodiments, the ionic liquid can include an imidazolium and/or pyrrole based ionic liquid, such as an imidazolium cyanopyrrolide ionic liquid.

In some embodiments, the poly(ionic liquid) comprises polydiallyldimethylammonium cyanopyrrolide.

In some embodiments, the substrate has a CO₂ permeance of at least about 100,000 GPU, at least about 125,000 GPU, or at least about 130,000 GPU.

In other embodiments, the substrate has a PES skin layer with an interconnected pore structure having a pore size of about 20 nm to about 50 nm or about 30 nm to about 40 nm.

### Example 1

In this Example, we address thermal and oxidative stability of a functionalized IL and examined the possibility of microwave regeneration as an alternative to the conventional thermal heating. Among the functionalized ILs, 1-ethyl-3-methylimidazolium 2-cyanopyrrolide ([EMIM][2-CNpyr]) has a superior CO₂ capacity, especially under low partial pressures of CO₂. With an effective reaction enthalpy of −50 kJ mole⁻¹, compared to aqueous amine-based sorbents at −80 kJ mole⁻¹, [EMIM][2-CNpyr]can be easily regenerated at mild temperatures (40° C. in anhydrous conditions); similar is true for the eutectic solvent based on this IL and ethylene glycol. Under moisture saturated conditions, further increase in temperature is needed (e.g., 90° C.). Therefore, it is important to understand the stability of these solvents upon repetitive absorption-desorption cycles and under exposure to air and oxygen, in particular for DAC processes. Due to its importance in CO₂ capture, the stability of [EMIM][2-CNpyr] under thermal and oxidative conditions as well as exposure to microwaves is examined here to guide the development of future liquid sorbents amenable to various regeneration approaches. In the subsequent paragraphs, we provide the current understanding of the thermal stability and degradation of imidazolium based ILs with the specific techniques applied to date. It is known that the degradation of imidazolium ILs may follow different mechanistic pathways under thermal and/or oxidative environments, depending on their anion pair. Therefore, the known degradation pathways for pyrrole-based compounds are also discussed.

The decomposition of ILs is commonly investigated using thermal gravimetric analysis (TGA) where a fast temperature ramp (e.g., 10° C./min) is applied usually under nitrogen and the degradation is reported based on the observation of significant mass loss. Recently, there has been improved methods for predicting long-term thermal stability by TGA by the control of furnace parameters. We examined the thermal degradation of [EMIM][TFSI], a common IL, under air and O₂ environments where a decomposition at a lower temperature was observed, compared to the N₂ environment. Few studies examined thermal degradation under isothermal conditions where lower thermal degradation temperatures were determined compared to the temperature ramping method in TGA. When the ethyl chain was replaced by a hexyl on the cation, the weight loss under same conditions increased to more than 10 wt %, thus showing the negative impact of the alkyl length attached to imidazolium on thermal stability. Similar results were observed with Rotating Bomb Oxidation Test (RBOT-ASTM D2272) conducted under O₂ with initial pressure of 620 kPa and at 150° C. The oxidative and thermal degradation mechanism was proposed based upon the radical intermediate formation along the alkyl chain attached to the imidazolium cation. The proposed mechanism was not confirmed, although others have shown degradation of imidazolium ILs with different alkyl and aryl substituents to take place via a radical formation with advanced oxidation processes including exposure to ultraviolet (UV), UV/H₂O₂, UV/TiO₂, 7.2Fe/TiO₂/H₂O₂ systems, as well as excited state oxygen (O •- or 100).

Under highly basic conditions (e.g., fuel cells), the degradation of imidazolium-based materials in the presence of an organic solvent or aqueous electrolyte are shown to undergo a nucleophilic attack. The proposed degradation pathways shown in Scheme 1 are: (1) reverse Menschutkin (S_{N}2) reaction; (2) nucleophilic addition-elimination followed by ring-opening; (3) ylide formation via deprotonation by nucleophile; or (4) deprotonation of the ring. Pathways 1 and 4 involve reactions in the peripheral alkyl substituents, whereas the pathways 2 and 3 are reactions directly involving the imidazolium ring. Density functional theory (DFT) calculations indicate the dominant pathway to be 2 involving the C2 position of the imidazolium ring. Therefore, bulky substituents on C2, C4, and C5 positions of the imidazolium are suggested to prevent the deprotonation of liable hydrogen, thus achieving higher stability.

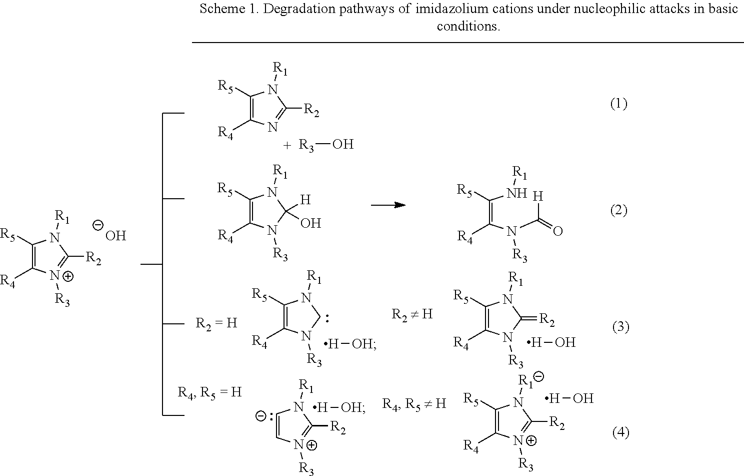

The pairing of the imidazolium cation with a basic anion, such as [2-CNpyr], is desired to increase the absorption capacity at low partial pressures of CO₂. The amine functionality, similar to the case reported for amino-oligomers in the context of their application in DAC can follow a basic auto-oxidation scheme. While the stability of the pyrrolides within ILs have not been examined before, the autoxidation of unsubstituted pyrrole and alkyl and aryl substituted pyrroles under air have been reported. It is agreed that the degradation pathway of pyrrole, under the stimuli of oxidants (i.e., peroxides, singlet oxygen (¹O₂), meta-chloroperoxybenzoic acid (m-CPBA), ferric chloride etc.), pH, and temperature or via anodic oxidation, often leads to unconstrained de-aromatization, polymerization, and decomposition that form complicated conducting (and/or nonconducting) polypyrrole (5 in Scheme 2). Furthermore, depending on the presence and position of the substituting group, products like 3-pyrrolin-2-ones or 4-pyrrolin-2-ones (6) and maleimide (7) are found in addition to dimers (8) through further coupling of pyrrole intermediates (Scheme 2). The presence of electron withdrawing group on the peripheral substantially decreases the reaction rate of oxidation, as demonstrated by the photodegradation of nesticides like Fludioxonil that contain pvrrole.

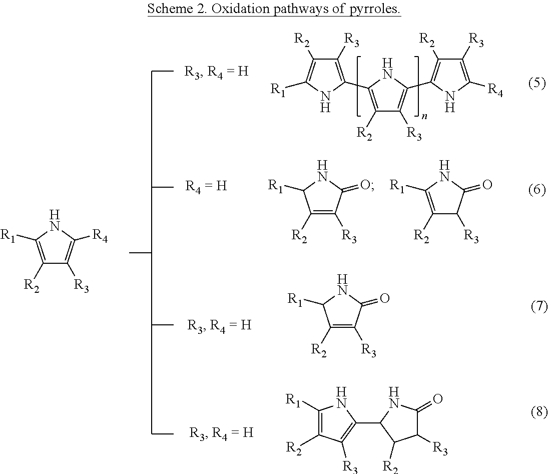

Here, the thermal and oxidative stability of [EMIM][2-CNpyr] is studied under air at 50 and 80° C., thus capturing conditions of a DAC process with absorption-desorption cycles. Under accelerated testing conditions where IL was exposed to pure O₂ and kept isothermally at 80° C. for 7 days, the degradation products and possible mechanism are determined by NMR, FTIR, MS, and operando GC. The impact of thermal and oxidative degradation of the IL on its density, viscosity, CO₂ absorption capacity, and species diffusivity are examined. Furthermore, MW based regeneration is demonstrated as an alternative approach where no measurable degradation occurred at both 80 and 100° C. The cyclability of the IL with MW exposure is shown with no CO₂ capacity loss, thus demonstrating the effectiveness of dielectric heating for IL regeneration for DAC for the first time.

### Methods

### Materials

The IL precursor, 1-ethyl-3-methylimidazolium iodide ([EMIM][I], >98%) was purchased from TCI America. Reagent grade solvents of methanol, acetone, isopropanol, anion precursor pyrrole-2-carbonitrile (97%), and anion exchange resin (AER) Amberlite® IRN-78 (hydroxide form) was purchased from Alfa Aesar (Thermo Scientific). Anion exchange resin was rinsed with methanol for at least three times and vacuum dried under ambient temperature before use. Paramagnetic compound chromium (III) acetylacetonate (Cr(acac)₃) and pyrrole (98%) were purchased form Sigma-Aldrich (Millipore Sigma). The deuterated solvent DMSO-d₆ (10 mL, 99.9%) was purchased from Cambridge Isotope Laboratories. The non-nucleophilic (also non-CO₂ reactive) ILs 1-ethyl-3-methyl-imidazolium bis(trifluoromethylsulfonyl)imide ([EMIM][TFSI], 99%) and 1-ethyl-3-methyl-imidazolium tricyanomethanide ([EMIM][TCM], 99%) were purchased from Iolitec Inc, Germany. The thrift-grade NMR tubes (5 mm diameter; 7″ length) and coded closed caps were purchased from Wilmad Labglass. The NMR coaxial tube sets (NE-5-CIC and NE-UP5-7) were purchased from New Era Enterprises, Inc. Gas tanks of nitrogen (N₂; Ultra High Purity (UHP), argon (Ar; UHP), helium (He; UHP), carbon dioxide (CO₂; bone dry), oxygen (O₂; UHP), hydrogen (H₂; UHP), and synthetic air (Air; N₂ 80% and O₂ 20%) were purchased from Airgas, Cleveland.

### Synthesis

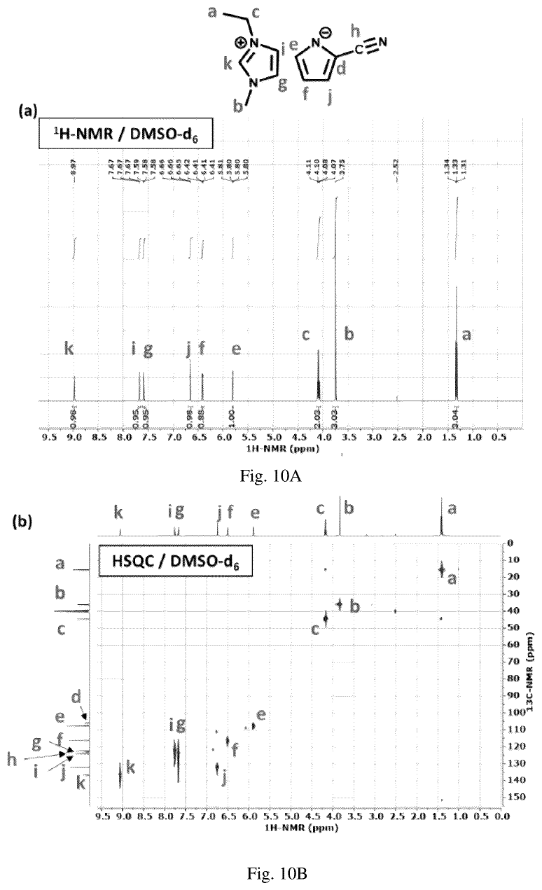

The synthesis of [EMIM][2-CNpyr] and [EMIM][Pyr] started with gradual anion exchange of precursor (10 g [EMIM][I] in 100 mL methanol) from I⁻ to OH⁻ at ambient temperature of 22° C. The use of AER was monitored to be 5 g per mmol of [EMIM][I]. The absence of residual iodide in the [EMIM][OH] intermediate was confirmed by (0.171 N) silver nitrate test where no visible white or yellowish silver(I) iodide precipitate was observed. Anion precursor was then added dropwise to the [EMIM][OH]/methanol intermediate solution ([EMIM][OH]: anion precursor 1:1.05 mole ratio) and agitated at 22° C. overnight. The resulting solution was then transferred to a round bottom flask where excess solvent was removed by a rotary evaporator with a vacuum pump (Edwards E2M0.7) at 50° C. The removal of residual moisture was carried out in a switch valve-controlled steel chamber under high vacuum of <100 mTorr with an Edwards RV-8 pump at 70° C. overnight. The molecular structure of [EMIM][2-CNpyr] was confirmed by ¹H-NMR and the peak assignment confirmed by heteronuclear single quantum coherence (HSQC) as shown in FIG. 10. Combustion ion chromatography (Atlantic Labs) confirmed the halogen content in [EMIM][2-CNpyr] to be lower than its detection limit (0.25%). Elemental analysis calculated for C₁₁H₁₄N₄: C 65.32, H 6.98, N 27.70, found: C 62.78, H 7.15, N 26.87.

### Characterization Methods

The molecular structure of ILs were characterized by nuclear magnetic resonance spectroscopy (NMR: ¹H, ²H, and ¹³C-NMR on a Bruker Avance III HD 500 MHz NMR Spectrometer equipped with Broadband Prodigy TCI CryoProbe). Fourier-transformed infrared spectroscopy (FTIR) was taken on a Nicolet iS50 (Thermo Scientific) with built-in mid- and far-IR capable diamond attenuated total reflection. Water contents of the IL samples were measured by Karl Fisher titration (Metrohm Coulometric; KF 889D) to be all less than 1000 ppm. Densities were measured with a vibrating U-tube density meter (Anton Paar; DMA 4500M) within its own temperate control chamber (±0.03 K). The uncertainty of density is ±0.00005 g/cm³. Viscosity was measured with a microchannel viscometer (Rheosense; MicroVISC) in temperature control unit (±0.10 K). The uncertainty of viscosity is about 2%. Thermal stabilities were measured by a thermogravimetric analyzer (TGA, Q500) with a few drops (˜15 μg) of anhydrous IL sample in a platinum pan. The samples were tested with a temperature sweep from 50 to 600° C. at a rate of 10° C./min, under either N₂ or air atmosphere.

### Accelerated Degradation Tests and Component Analysis

2 mL of IL sample was placed in a 20 mL glass vial and agitated at 60 rpm with a magnetic stirrer (IKA C-MAG HS 7 digital). The head space within the glass vial was about 18 mL. A total of four accelerated degradation tests, corresponding to samples 1-4, were performed as summarized in Table 1. Sample 1 and Sample 4 were continuously contacted with air and O₂, respectively, and the evolving components were sent to the GC for analysis. Evolving gas analysis was carried out by a customized GC (Agilent GC 7890B) equipped with two thermal conductivity detectors (TCD1, mobile phase: He; TCD2, mobile phase: N₂) and one flame ionization detector (FID1; mobile phase: He). Degradation tests for Sample 2 and 3 were performed in gas-tight 20 mL glass vials, with about 18 mL of air and O₂ as the atmosphere, respectively. The targeted atmosphere was purged into the vial for 10 min to replace the atmosphere before sealing the vial with lid and parafilm. Samples were degassed overnight by pulling vacuum and kept in an argon filled glovebox (VTI, with H₂O and 02 both less than 0.1 ppm). The water content before and after the degradation tests were measured by KF titration to be <1000 ppm. Samples 1 and 4 were analyzed by electrospray ionization mass spectroscopy (ESI-MS; TSQ Quantum XLS Ultra). IL samples with a concentration of 25 mM in acetonitrile-water (v/v 50/50) mixture were directly infused and scanned in the range of 50˜600 m/z, with 0.1 mol % of acetic acid as additive for the positive scan and with no additive for the negative scan.

### CO₂ Capacity Measurements Before and After Degradation

CO₂ capacities were measured for the neat IL and Samples 1 and 4 following a similar procedure as described previously. Briefly, mass flow controllers (MFC; Brooks 5850i) were used to create mixed anhydrous feeds of CO₂ and N₂ at 410 ppm and 2500 ppm of CO₂. Complete mixing of the gas was ensured in a 300 mL metal chamber (Swagelok) within an isothermal incubator (HettCube 400R; Across International LLC) at 22° C. prior to the absorption cell (20 mL glass vial). The CO₂/N₂ gas flow rate and composition were confirmed by an ADM 2000 Flowmeter (J&W Scientific Inc., acquired by Agilent) and an infrared gas analyzer (SBA-5, PPSystems Inc.), respectively. Analysis of the absorbed CO₂ in the IL was done by quantitative ¹³C-NMR, following a previous report.

### Ion Self-Diffusivity Measurements

Diffusion coefficient of the ions within the IL samples (1 and 4) was measured by Diffusion-Ordered Spectroscopy (DOSY) NMR using a bipolar gradient (ledbpgp2s) pulse sequence on a Bruker 500 MHz NMR (¹H Larmor frequency of 500 MHz) with Z-gradient diffusion probe. The signal was accumulated over 16 transients with 4 s delay at 298 K. The isotopic self-diffusivity (D) of ions was calculated using equation 1.

$$M ( g ) = {M}_{0} {e}^{[ - {( γ g δ )}^{2} D ( Δ - \frac{δ}{3} ) ]} \qquad eqn . 1$$

where γ is the gyromagnetic ratio, g is the magnitude of the gradient pulse, 6 is the duration of the gradient pulse, and Δ is the interval (drifting time) between two gradient pulses in opposite direction. M₀ is the strength of magnetization without pulse field gradient applied, whereas M(g) is a function of the applied pulse field gradient. The A and 6 was set to be 190 ms and 3 ms, respectively.
   CO₂ Absorption and MW-assisted CO₂ Regeneration

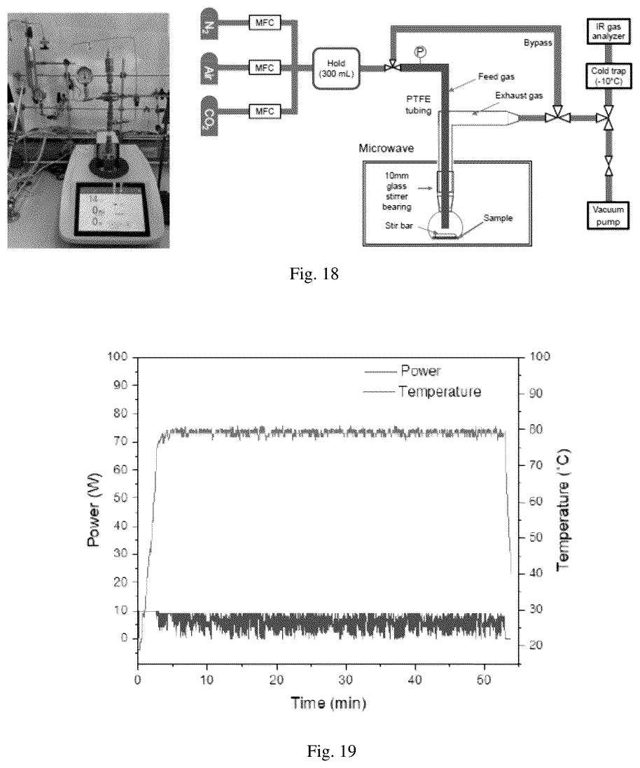

For CO₂ breakthrough measurements, 5 mL of IL sample was placed in a 125 mL flat-bottom Pyrex glass flask and the sample was pretreated by microwave exposure at 50° C. for 4 hrs under air flow to confirm stability. Following this, absorption measurement was performed by contacting the sample with anhydrous CO₂/N₂/O₂ gas feed (5000 ppm CO₂ in synthetic air; 80/20 N₂/O₂) at a flow rate of 400 mL/min for 2.5 hours while constantly stirring the liquid. Absorption was followed by desorption via microwave exposure for 1 hr. The setup is shown in FIG. 18 and a representative power and temperature profile are shown in FIG. 19. The amount of CO₂ absorbed/desorbed was determined by quantitative ¹³C-NMR analysis of the liquid and the CO₂ in the exhaust was quantified by the IR analyzer according to the procedure reported previously. Dielectric heating to maintain a constant temperature of the liquid sample for desorption at 80 or 100° C. (IR temperature sensor with uncertainty of ±1° C.) was achieved by automatically adjusting the continuous MW power (CEM Discover 2.0; 2. 45 GHz, 1-300 W). The desorbed CO₂ was swept by N₂ flow (400 mL/min) to the IR gas sensor. This procedure was repeated for the second absorption-desorption cycle. Possible degradation during MW exposure was assessed by NMR and FTIR spectroscopy. Viscosity of the sample post cycling was also measured as described earlier.

### Results and Discussion

### Analysis of Oxidative and Thermal Degradation

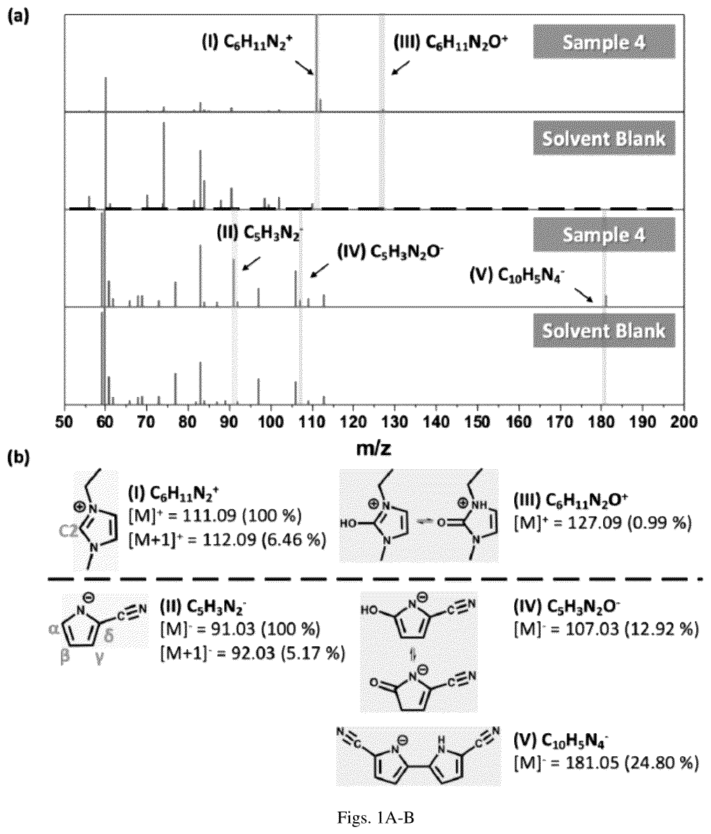

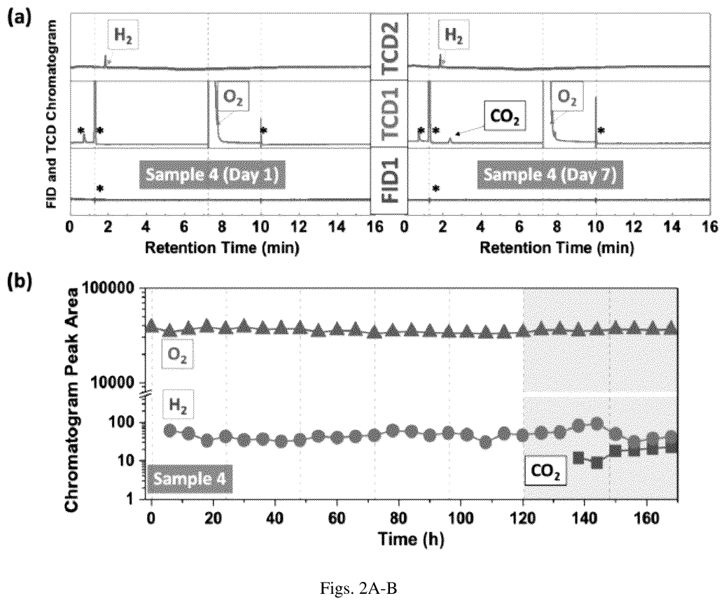

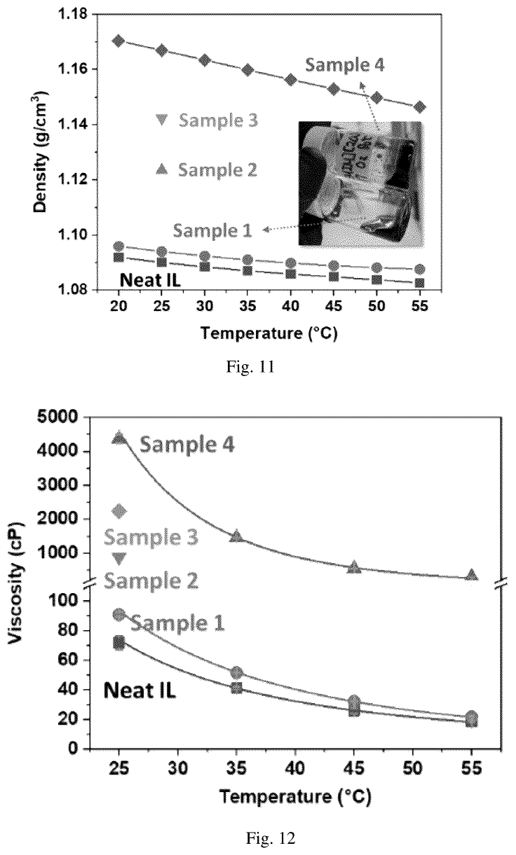

The synthesis of the IL was confirmed by NMR as shown in FIG. 10. The accelerated degradation of [EMIM][2-CNpyr] was conducted under conditions specified in Table 1. Degradation upon extended exposure of the IL to O₂ and heat resulted in thickening and darkening of the liquid (inset images in FIG. 11). The measured density (FIG. 11) and viscosity (FIG. 12) for the degraded samples were measured to be higher than those of the neat IL, suggesting the compacting of the liquid perhaps due to the increased inter- and intramolecular interactions and reactions leading to additional species. FIG. 1 shows the product identification by MS of most degraded IL by direct infusion of Sample 4.

TABLE 1
Conditions of the accelerated thermal and oxidative degradation
experiments for [EMIM][2-CNpyr]

| | Exposure History | | | |
|---|---|---|---|---|
| | | Time | Temperature | |
| | Atmosphere | (days) | (° C.) | Method |
| Sample 1 | Air | 3 | 50 | Continuous feed of air |
| | | | | with 5 sccm flow rate |
| Sample 2 | | 7 | 80 | Air atmosphere in |
| | | | | the head space |
| | | | | of 20 mL vial |
| Sample 3 | O₂ | 7 | 80 | O₂ atmosphere in |
| | | | | the head space |
| | | | | of 20 mL vial |
| Sample 4 | | 7 | 80 | Continuous feed of O₂ |
| | | | | with 5 sccm flow rate |

Both positive and negative MS analysis of the sample is plotted in blue in FIG. 1A. The highlighted peaks are the difference between sample infusion and solvent blank. The parent components [EMIM]⁺ (I) and [2-CNpyr]⁻ (II) appear at [M]⁺=111 and [M]-=91, respectively. The small satellite peaks at [M+1] for each of these are caused by the presence of the ¹³C isotope (1.11% of ¹³C natural abundance) in the molecule (percentages listed in FIG. 1B). The relative peak heights of the [M+1] peak over the parent peak, can be used to verify the number of carbon atoms within the molecules. The ratio of 6.58% for a six-carbon molecule and 5.53% for a five-carbon molecule are expected. Indeed, these values are close to that of 6.46% of (I) and 5.17% of (II) as calculated from the observed intensity ratios in FIG. 1B.

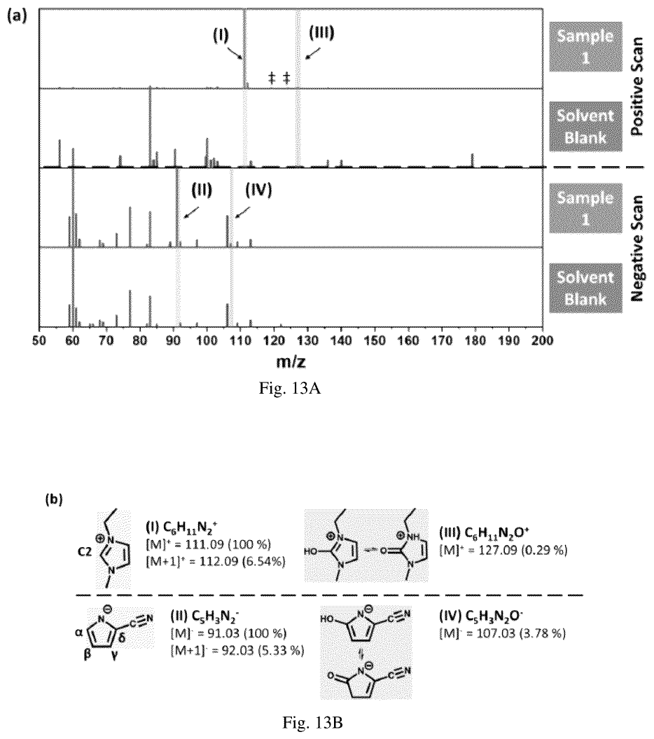

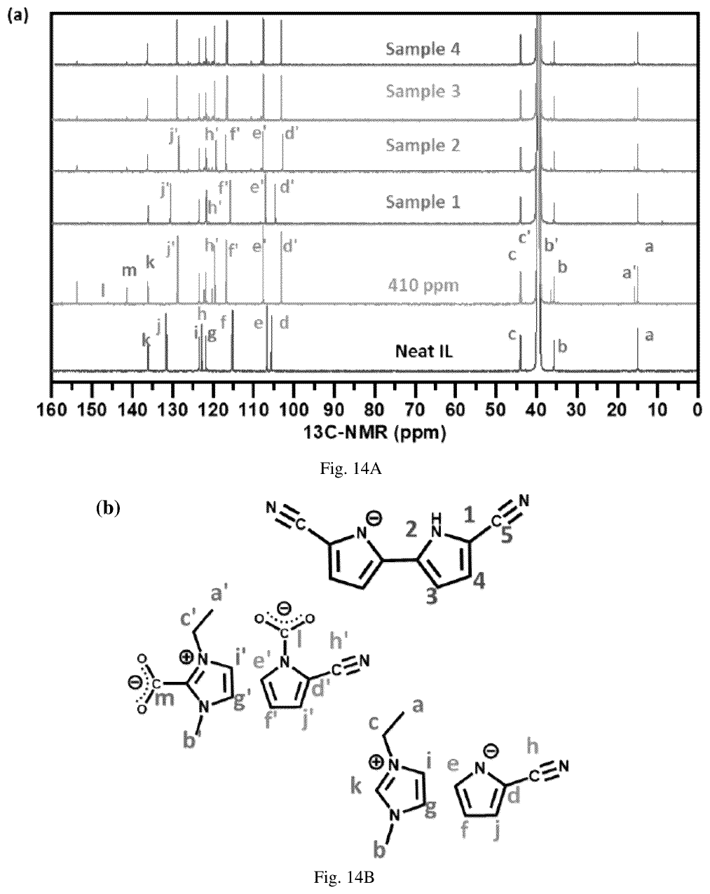

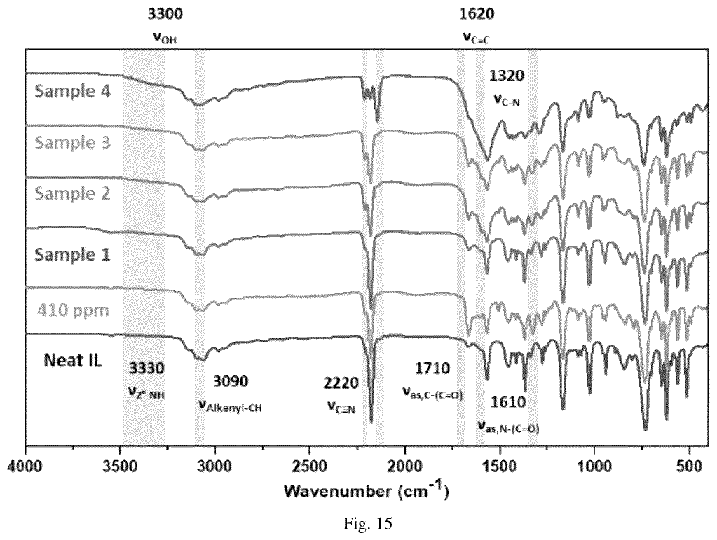

Based on the MS analysis, there are two oxidative degradation products labeled as (III) and (IV) in FIG. 1B representing the oxidized cation and the oxidized anion, respectively. While there is no literature reporting directly on the oxidation of imidazolium under O₂ at 80° C., the most relevant studies that involve the presence of [OH]⁻, ¹O₂, and [O₂]⁻ point to the most reactive site being the C2 position on the imidazolium compounds. Therefore, a similar nucleophilic attack by oxygen radical on the cation likely takes place at the C₂ position (Scheme 3a). On the other hand, the radical formation in the anion is most likely at the α position (Scheme 3b), due to the greater number of intermediate resonance states in contrast to the β or γ carbon (Scheme 3b). The oxidative degradation of the cation begins with the radical cleavage of hydrogen on the C2 carbon as shown in Scheme 3a, followed by the attack of an oxygen molecule that results in the formation of a peroxide radical. With the capture of a hydrogen radical, the peroxide radical then turns into peroxide, which breaks down and eventually producing the oxidized cation. The oxidized cation is believed to be in equilibrium with its amide tautomer. The oxidation of the anion is expected to follow similar pathway as shown in Scheme 3b. It is noteworthy that both oxidative degradation products were observed even under mild degradation environments of Sample 1 (FIG. 13).

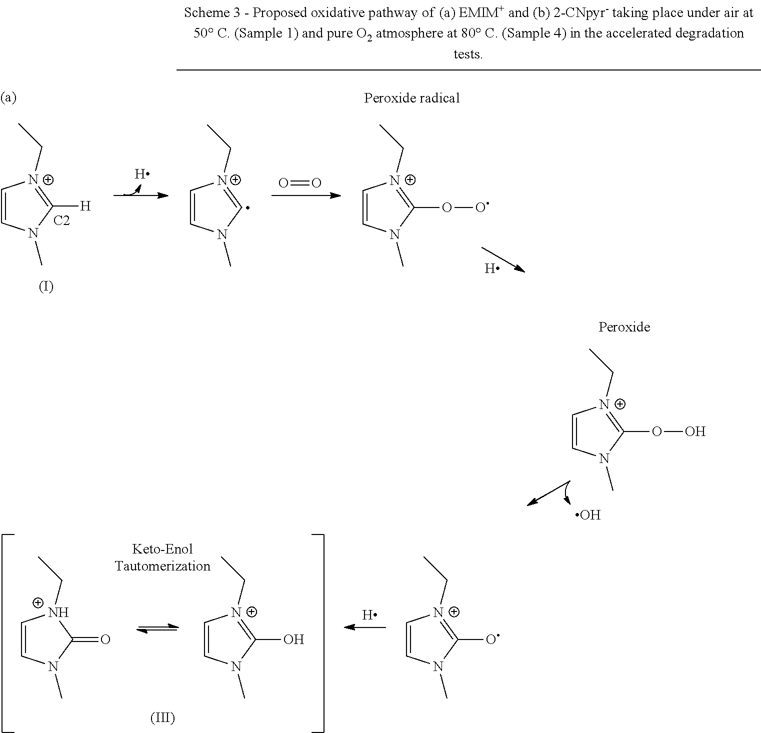

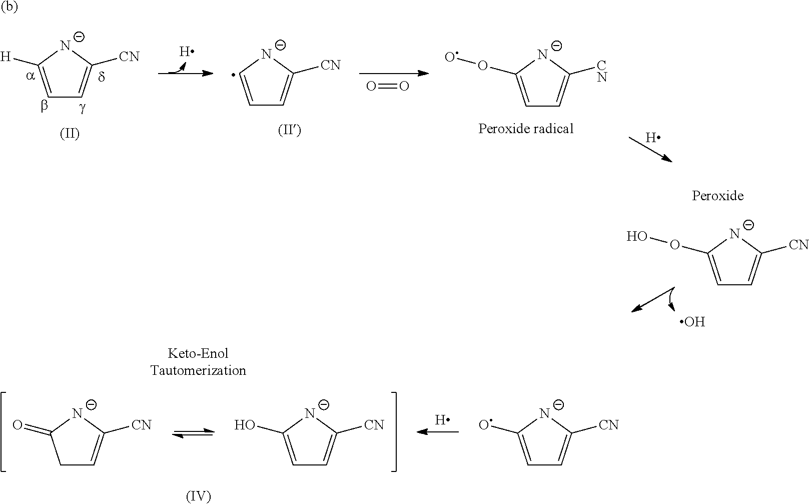

Along with the oxidative products determined in Sample 4, we identified an additional peak at m/z=181 in the negative scan of FIG. 1A, representing the anion dimer which was not observed in Sample 1. We speculate this dimerization to be dependent on the radical concentration for the anion, which increases with greater oxygen exposure at elevated temperatures (Scheme 4a). The anion dimer forms through the C—C bond formation of the carbon radical at the a position of the anion and the hydrogen radical likely results in H₂ gas. The anion dimer is likely to be a dianion [C10H4N4]²⁻ but could be readily protonated to be [C10H5N4]⁻. Different from the formation of ring-like oligomers or linear polymers from pyrrole under various stimuli, the lack of liable proton at the 6 carbon limits the chance of chain propagation and ends the decomposition of the anion with a dimer. These results are in agreement with the report by Li et al. on the radical-induced degradation of amino-oligomer sorbents where varying oxidative stability (and kinetics) was observed based on the local environment of the amine.

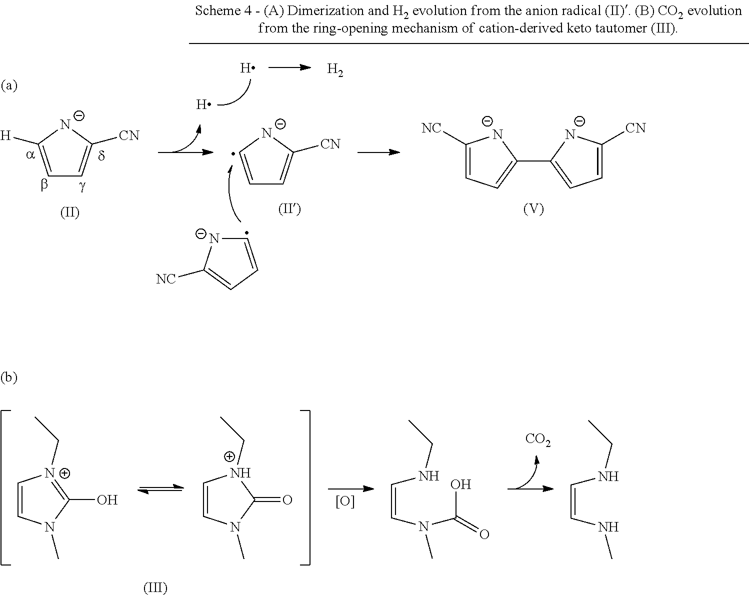

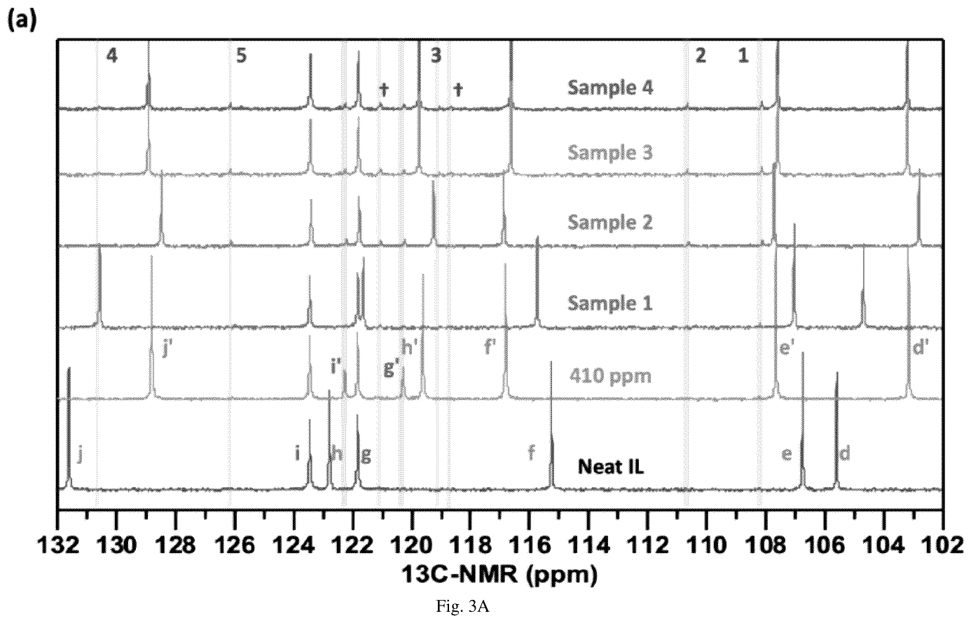

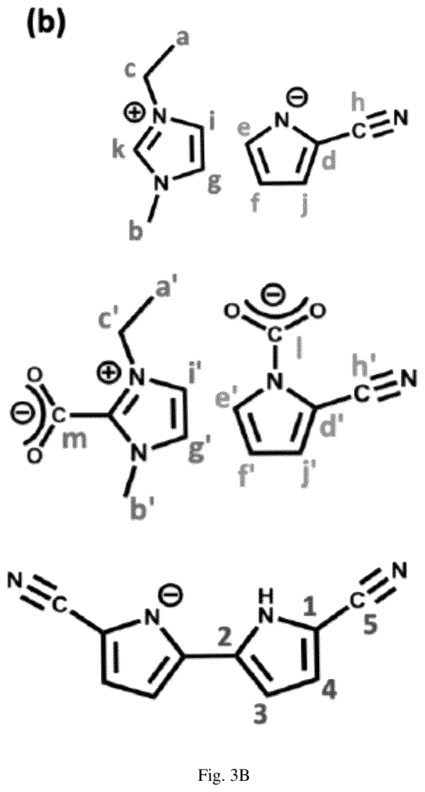

To confirm the proposed degradation reactions, a series of analysis consisting of GC (for gaseous side products), NMR, and FTIR was performed. Off-gas operando GC analysis was conducted on Samples 1 and 4 throughout the period of the accelerated degradation experiments. H₂ evolution from Sample 4 was detected by TCD2 (FIG. 2A); it was quantifiable after six hours as seen in FIG. 2B. We interpreted the H₂ to be coming from the cleaved-off hydrogen radical from the α position (Scheme 4a), leading to the formation of the anion dimer observed in MS. The dimerization in Sample 4 is further supported by ¹³C-NMR in FIG. 3 (small peaks highlighted in orange). In contrast, neither H₂ evolution nor the anion dimerization were observed in other degraded IL samples. A possible explanation to this observation is the stronger dependence of these side reactions to O₂ concentration, in which case the likelihood of two anion radicals being near each other is high enough to form the dimer.

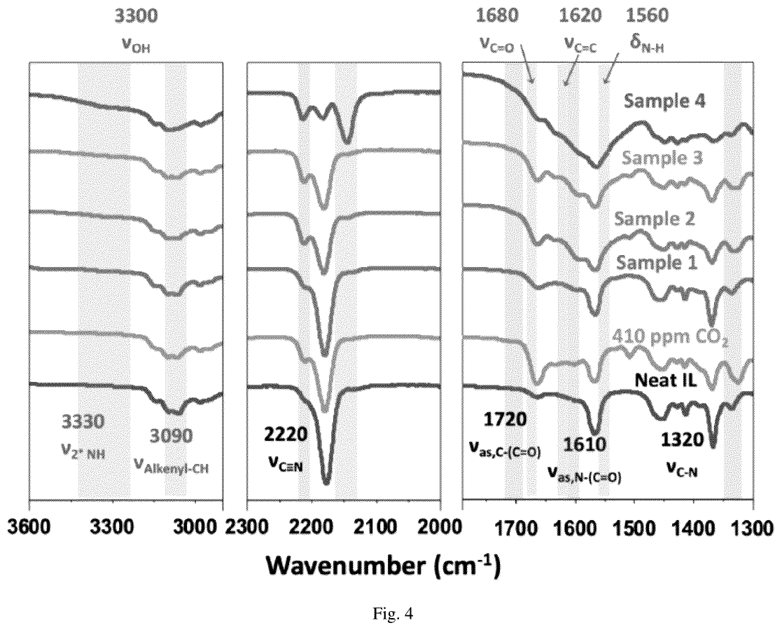

The regions highlighted in green in FIG. 4 confirm the formation of the proposed oxidized products (hydroxide O—H stretching at 3300 cm⁻¹) and their amide tautomers (amide N—H bending at 1560 cm⁻¹ and amide C═O stretching at 1680 cm⁻¹), as well as the ring-opening product (secondary amine N—H stretching at 3330 cm⁻¹, alkenyl C—H stretching at 3090 cm⁻¹, and alkenyl C═C stretching at 1620 cm⁻¹). The orange region suggests the potential oxidation of cyano groups under extensive oxidative condition in Sample 4. It is also possible that additional —CN vibration is due to the presence of the different environments with the anion dimer formation. These observations in NMR and FTIR strengthen our proposed anion dimerization and ring-opening reaction pathways in Scheme 4. Aside from the dimerization reaction of the anion, we also observed the emission of CO₂ gas starting from day 6 in the chromatogram of TCD2 (FIG. 2A) which is highlighted in the gray shaded region in FIG. 2B. We hypothesize that the emission of CO₂ is from the pathway shown in Scheme 4b, where a ring-opening reaction of the keto tautomer of the oxidized cation takes place. Based on these results, we conclude that the oxidative degradation reactions strongly depend on the temperature and O₂ concentration.

The degradation-derived CO₂ binds back to the ILs as indicated by the gray highlighted peaks in ¹³C-NMR (FIG. 3) and FTIR (FIG. 4) that correspond to the bound CO₂. The split of the cation peaks (g′ and i′) and the shift of the anion peaks (d′, e′, f′, h′, and j′) in NMR present consistent behavior with our previous study, where the specific CO₂ binding mechanism with this IL was reported. FIG. 3B shows the CO₂ complexed cation and anion species of carboxylate and carbamate, respectively, in the middle. We considered the possibility of potential oxidation of polyethylene tube in the gas line as the CO₂ source; however, experiments carried out without these tubing components (Samples 2 and 3) yielded similar results of CO₂ evolution and binding to IL. Therefore, we conclude the evolution of CO₂ to be a product of the cation degradation as suggested in Scheme 4b.

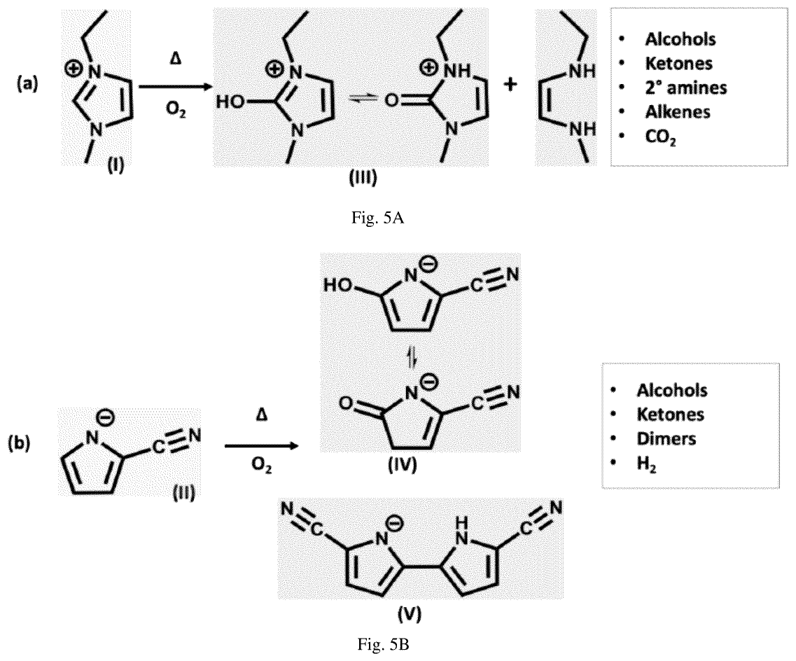

While the exact molecular structures of some degradation products were difficult to fully characterize by FTIR, NMR or MS due to their low concentrations, potential degradation pathways are proposed based on cross-referencing the spectroscopic results (FIG. 5). The viscosity increase in degraded IL may be related to the formation of stronger Coulombic interactions between the cation and the dianion as well as H-bonding between the alcohol and amine groups, in addition to the oxidized and polymerized products.

### The Impact of Anion Nucleophilicity on Stability

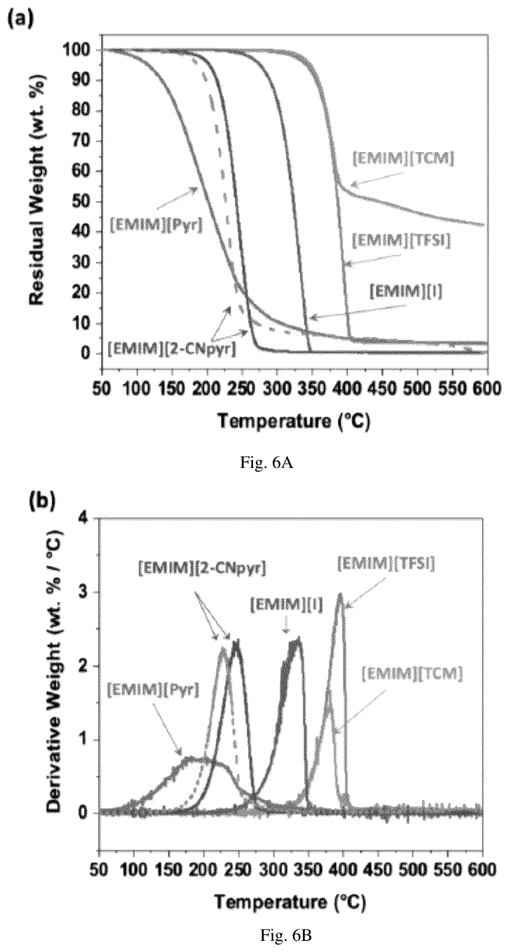

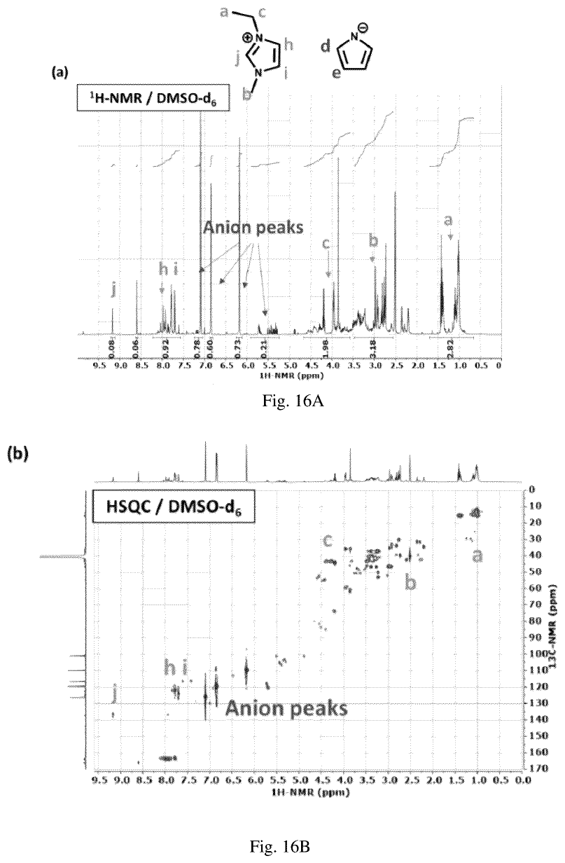

The nucleophilicity of the anion was reported to be a critical factor for stability. A ramped gravimetric analysis of [EMIM]-based ILs (or salts) with varied anion nucleophilicity (Table 2) was performed with TGA. ILs with low nucleophilic anions like [TFSI] and [TCM] were observed to have the highest thermal stability of at least 350° C. (FIG. 6A), which is even better than the cation precursor [EMIM][I]. This demonstrates that the thermal decomposition of [EMIM]⁺ cannot be decoupled from its counterion, and, in fact, the anion has a dominant role in driving the degradation of the IL. The first derivative of TGA curve (mass loss) against temperature is given in FIG. 6B to clearly demonstrate the trend. The increase in the nucleophilicity of the anion from [TFSI] to [2-CNpyr]lowers the decomposition temperature by 100° C. When the electron withdrawing cyano (C—N) substitution is eliminated as in the case of [Pyr], thus increasing the nucleophilicity of anion, the resulting compound [EMIM][Pyr] demonstrates very low thermal stability. The strong nucleophilic [Pyr] will decompose the cation. In fact, the decomposition is so profound that [EMIM][Pyr] is not even stable as evident from ¹H-NMR (FIG. 16), where it readily degrades. Under air, the thermal stability of [EMIM][2-CNpyr](dashed line in FIG. 6) was also found to be lower when compared to N₂ environment (solid line) by about 10° C. in decomposition temperature.

TABLE 2
Imidazolium-based samples with different anions and nucleophilicity. Donor number
defines the reaction enthalpy of a Lewis base binding to a standard Lewis acid and is therefore a
good indicator of anion nucleophilicity

| | | | Donor number |
|---|---|---|---|
| | | | (kcal mol⁻ |
| Anions | Full name | Molecular structure | ¹)[69]9 |
| [TFSI] | Bis(trifluoromethanesulfonyl)imide | 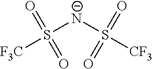 [SMILES: O=S(=O)([N-]S(=O)(=O)C(F)(F)F)C(F)(F)F] | 11.2 |
| [TCM] | Tricyanomethanide | 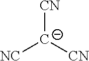 | 26.1 |
| [I] | Iodide | 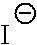 | 59.3ª |
| [2-CNpyr] | 2-Cyanopyrrolide | 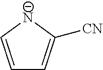 | N/A |
| [Pyr] | Pyrrolide | 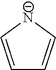 | N/A |

^{a}Donor number measured with 1-octyl-3-methylimidazolium iodide [OMIM][I], instead of [EMIM][I].

### Impact of Temperature and Oxygen on Ion Diffusivities and CO₂ Capacity

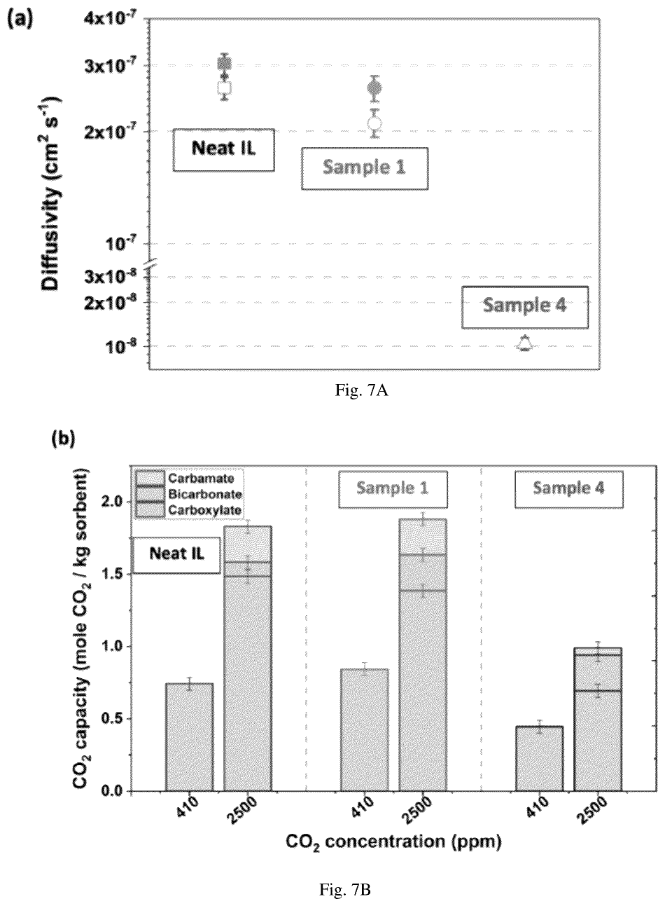

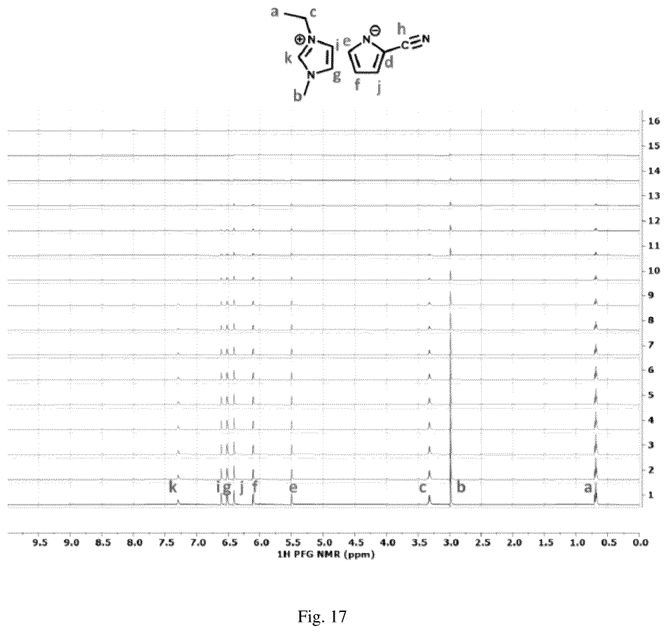

The self-diffusivity (D) of the cation and anion were measured by ¹H DOSY NMR (calculated using Equation 1) and plotted in FIG. 7A. An example of the ¹H pulse field gradient (PFG) NMR for diffusivity calculation is shown in FIG. 17. We would like to point out the limit of ¹H-NMR (and ¹H DOSY NMR), in which [iEMIM]⁺ and [iEMIM]⁺-derived components cannot be resolved effectively as separate entities; however, they appear as a single peak due to the low concentration of the [EMIM]⁺-derived components and the interactions among them via H-bonding. A similar limitation also applies to [2-CNpyr]⁻. While both the [IEMIM]⁺ and [2-CNpyr]⁻ ions are composed of five-member heterocyclic aromatic ring-structure with short pendent groups, giving similar hydrodynamic radius, the diffusivity of anion (D⁻) in the neat IL is observed to be slightly slower than that of cation (D⁺). This is likely due to the stronger H-bonding interactions between the conjugated [2-CNpyr]⁻/2-CNpyrH adduct. The ratio of D⁺/D⁻ is referred as the “R value” which represents a measure of change in the surrounding solvation environment. The R value of Sample 1 (1.18) is similar with that of neat IL (1.21). On the other hand, Sample 4 gives an R value of 1.02 and a diffusivity that is one order of magnitude lower than other samples. This suggests a very different chemical environment in Sample 4, where the ions are relatively confined by higher order interactions in the presence of intermolecular H-bonds that thicken and compact the liquid, in alignment with the higher viscosity measured, as opposed to Sample 1 and the neat IL.

FIG. 7B shows the CO₂ capacity of the neat and the degraded IL Samples 1 and 4. The capacity was calculated via quantitative ¹³C-NMR by the integration of carbamate (CO₂-anion complex; 146 ppm), carboxylate (CO₂-cation complex; 154 ppm), and bicarbonate (CO₂-water; 158 ppm). With mild exposure history in Sample 1, we observed similar CO₂ capacity under 410 and 2500 ppm of CO₂ in N₂ post decomposition tests. However, the measured capacity of Sample 4 decreased by about 50%, which could be traced back to the loss of both active sites of carboxylate on cation (154 ppm) and carbamate on anion (146 ppm). We hypothesized the deactivation of CO₂ binding sites to be related to the degradation of the IL itself, and possible hindrance from the intramolecular H-bond, which may impede CO₂ from accessing the active sites.

### Stability Against MW Exposure and CO₂ Release Via Dielectric Heating

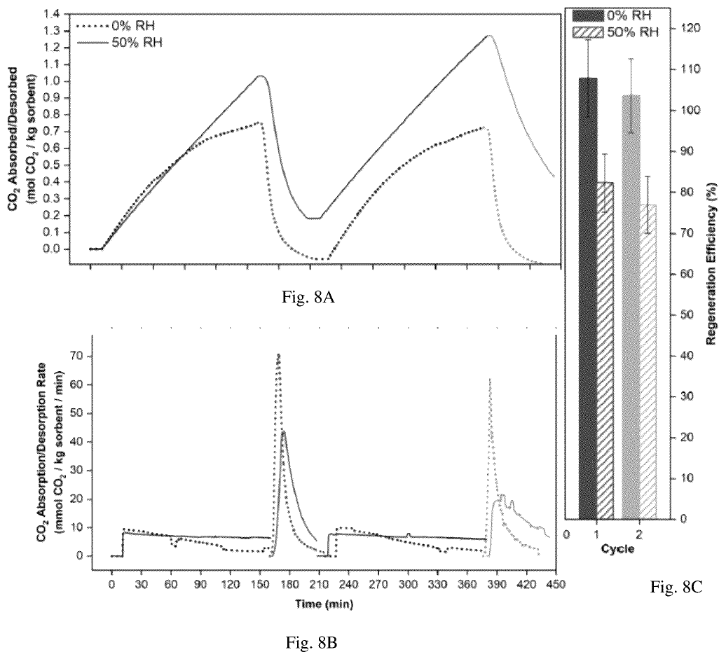

Microwave-assisted desorption was performed at a constant temperature (80 and 100° C. in two consecutive cycles) by auto-adjusting the microwave power (0-10 W at 2.45 GHz), following CO₂ absorption at 25° C. as shown in FIG. 8. The schematics of the setup is shown in FIG. 18. The representative temperature and MW power profile during desorption are shown in FIG. 19. Absorption was performed by contacting the IL with a feed gas of 5000 ppm CO₂ in synthetic air (80/20 N₂/O₂) at 25° C. with 0% RH. To achieve 50% RH (Ph2O=15.9 mbar), the feed gas was bubbled through a water reservoir. Desorption was performed by dielectric heating at 100° C. in the first cycle and 80° C. in the second cycle under dry N₂. When the absorption was under 0% RH, both the absorbed and desorbed amounts of CO₂ are the same in both the 1^{st} and 2^{nd} cycles (FIG. 8A), thus demonstrating effective desorption and cyclability. Here, the absorption time was limited to 2.5 hrs and the absorbed CO₂ does not reflect the thermodynamic equilibrium at 25° C. due to slow absorption rate. The rate of desorption is about 7.5 times greater than the absorption rate (FIG. 8B), likely resulting from reduced viscosity at higher temperatures and direct molecular level heating. In fact, desorption is rapid, and half of the absorbed CO₂ is released within the first three minutes.

With absorption at 50% RH, working capacity (difference between absorbed and desorbed CO₂ in a cycle) is decreased despite the fact that the absorbed amount of CO₂ is slightly increased. Therefore, the regeneration efficiency is around 80% (FIG. 8C). The increased absorption capacity under humid feed conditions is likely due to the CO₂ uptake by the absorbed water in the IL as it is known that water reacts with CO₂ in basic conditions forming bicarbonate and carbonate. However, it is also known the reaction enthalpy of bicarbonate and carbonate formations are higher than that of carboxylate and carbamate that forms from CO₂ absorption by the IL. Therefore, it is not surprising that the regeneration efficiency is lower in the 2^{nd} cycle where the temperature is lower.

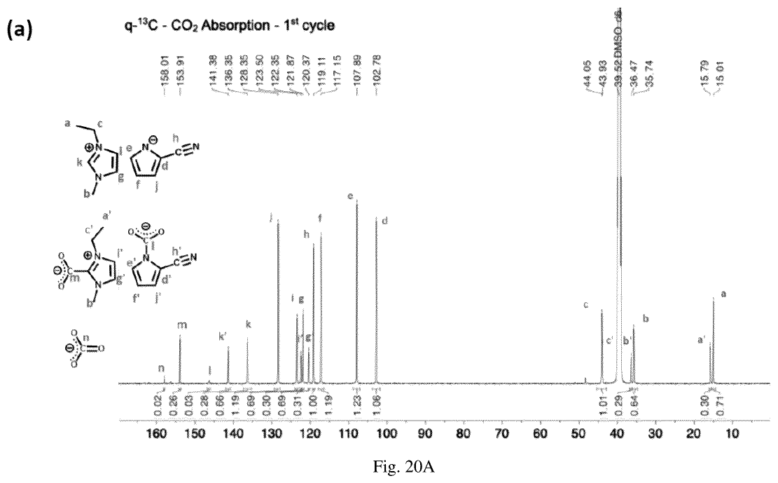

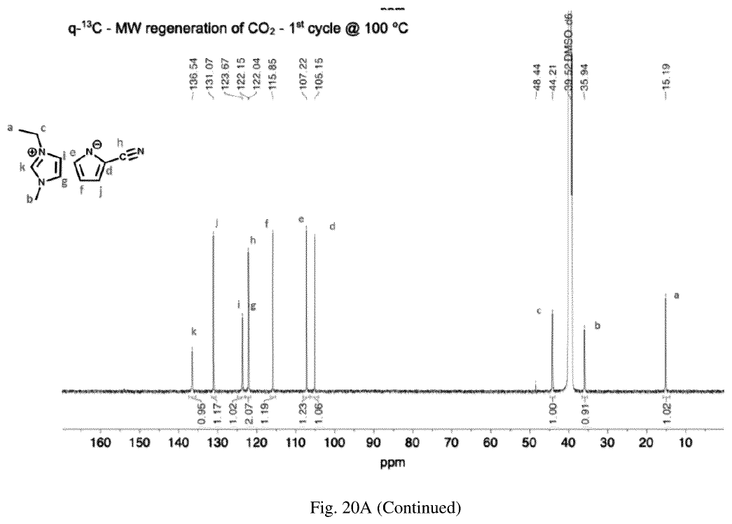

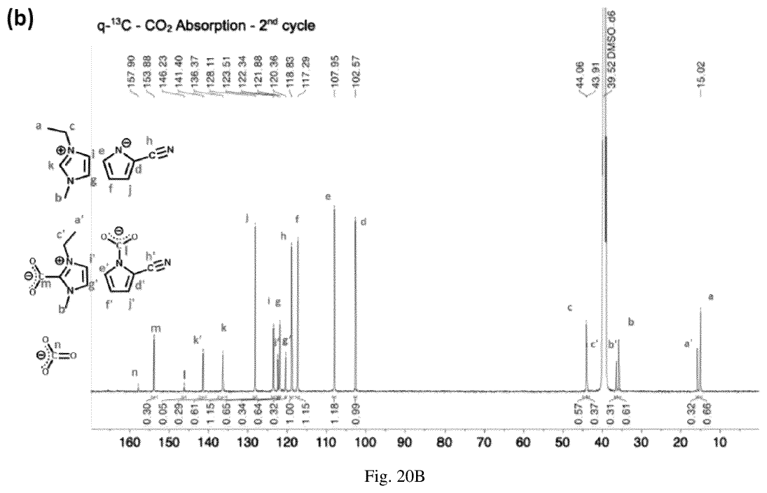

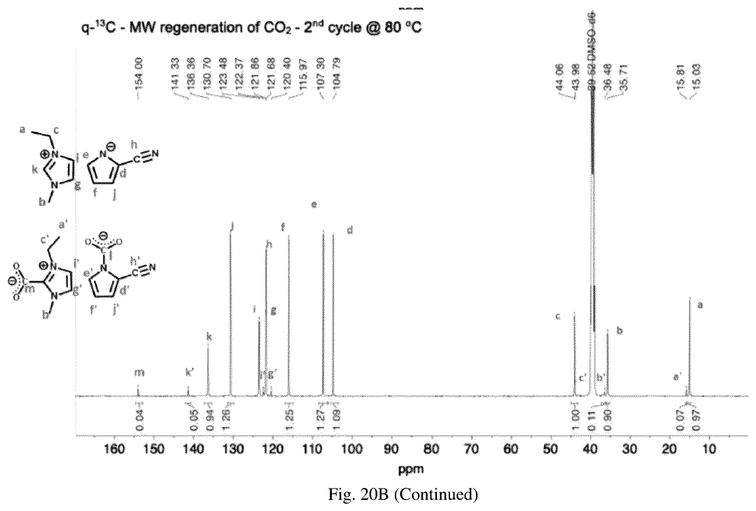

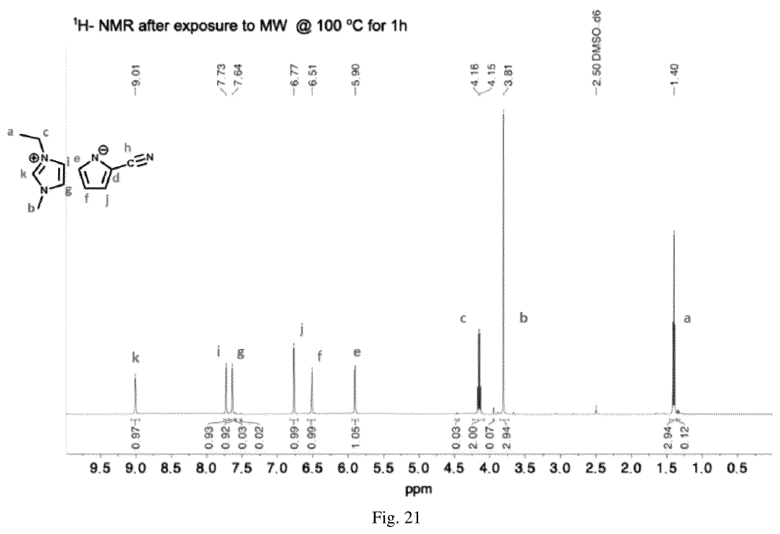

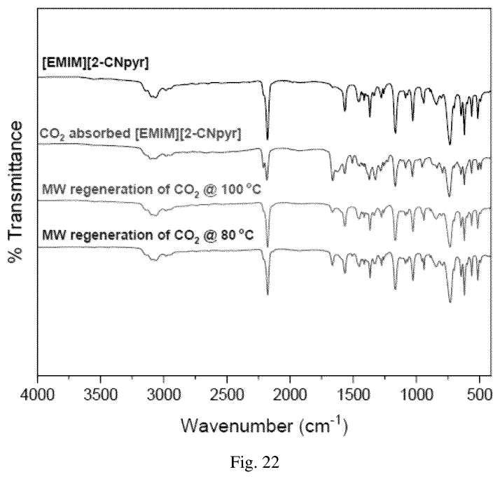

It is worth to note that the IL darkened in color after dielectric heating at 100° C. for 1 hour due to initiated IL oxidation which is probably very low in amount and thus could not been detected. After a total MW cycle of 6 hrs (4 hrs of pretreatment at 50° C., 1 hr of 1″ desorption at 100° C., and 1 hr of 2^{nd} desorption at 80° C.), the stability of IL (treated under 0% RH) was confirmed by NMR (FIG. 20) and FTIR (FIG. 21). Viscosity of the MW regenerated IL after the completion of breakthrough measurements under 0% RH was measured as 85 cP at 25° C. which is lower than the measured value of 90 cP for aged IL at 50° C. after 3 days via conventional heating, in comparison to 70 cP for the fresh sample prior to any absorption-desorption history.

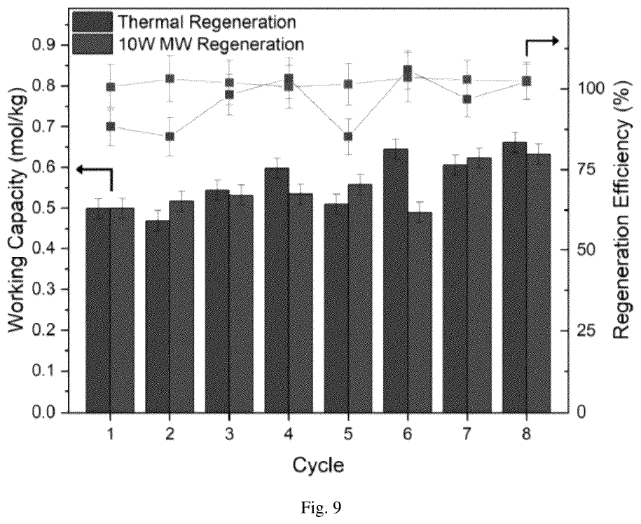

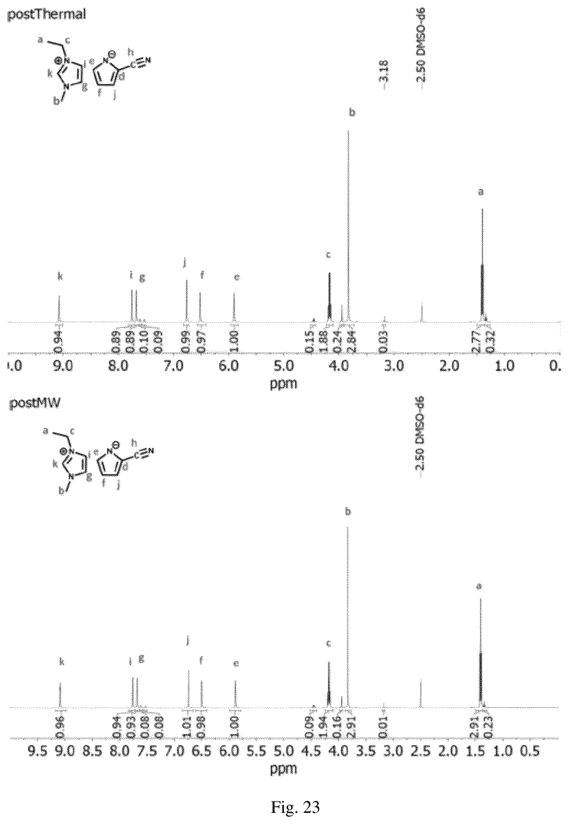

To compare MW regeneration with the convectional heating, parallel experiments were performed up to 8 absorption-desorption cycles (16 hrs total). Cycling was performed with a dry feed gas of 5000 ppm CO₂ in synthetic air for 60 min at 25° C., followed by desorption under N₂ for 45 min at 80° C. in both experiments using the same setup. The only difference was that the convectional heating was performed by immersing the sample chamber in a pre-heated oil bath at 80° C. as the heat source instead of dielectric heating via MW. As shown in FIG. 9, the MW regeneration resulted in almost similar working capacities compared to convectional heating but led to slightly more efficient and stable regeneration efficiency. Following cycling, both samples were characterized by NMR to identify possible degradation products; however none was observed (FIG. 23). These results demonstrate the utility of MW as a viable alternative to conventional heating in IL regeneration in CO₂ capture processes.

It is shown here that the CO₂-reactive IL is susceptible to dielectric heating and the desorption can be achieved effectively considering the high viscosity of the IL that limits mass transport. While [EMIM][2-CNpyr] was found to undergo thermal and oxidative degradation under O₂ at 80° C. for 7 days, therefore loosing 50% of its CO₂ capacity, it is relatively stable upon cycling under air feed gas and 80° C. regeneration. These results further demonstrate the superior stability of the functionalized IL, compared to the solid amines where CO₂ capacity loss in the orders of 80% and 61% have been reported under dry air at 120° C. and 80° C. for 7 days, respectively.

The CO₂-reactive IL, [EMIM][2-CNpyr], was exposed to air and O₂ at 50 and 80° C. for durations of 3 and 7 days to examine the possible oxidative thermal degradation reactions that could occur under a repetitive thermal-swing process that a sorbent undergoes in CO₂ capture. The results from a series of analytical measurements suggest oxidation of both ions and ring opening of the imidazolium by radicalic and S_{N}2 reaction mechanisms, respectively. These reactions were encouraged by the nucleophilicity of the anion producing mostly pyrrole dimer, ketones, and alkenes in addition to H₂ and CO₂ gases. While the CO₂ reactivity of the IL sorbents rely on nucleophilic functional groups, stronger nucleophilicity negatively impact sorbent stability upon long exposures to thermal cycling as evident by the measured increase in viscosity and loss of CO₂ capacity. Therefore, balancing of the nucleophilicity of an IL sorbent for CO₂ capacity and regeneration temperature is important. In order to eliminate the long exposures to high temperatures under conventional heating, MW regeneration was demonstrated as an alternative where no measurable degradation products were found after a total of 6 hours exposure to MW at 50-100° C. While this study demonstrates the susceptibility of IL for MW based regeneration and desorption of CO₂, it should be further investigated whether there is structure-induced release of CO₂ besides the dielectric heating effects.

Calculation of the theoretical relative peak heights in mass spectroscopy
For (I) C₆H₁₁N₂⁺, the probability of M+1 peak if considering all ¹³C, ²H, and ¹⁵N is:

$$6 \times ( \frac{1.11}{101.11} ) + 11 \times ( \frac{0.015}{100.015} ) + 2 \times ( \frac{0.37}{100.37} ) = 7.48 \%$$

with ²H and ¹⁵N often ignored due to their low abundancy, the probability of M+1 peak if considering only ¹³C is:

$$6 \times ( \frac{1.11}{101.11} ) = 6.58 \%$$

For (II) C₅H₃N₂; the probability of M+1 peak if considering all ¹³C, ²H, and ¹⁵N is:

$$5 \times ( \frac{1.11}{101.11} ) + 3 \times ( \frac{0.015}{100.015} ) + 2 \times ( \frac{0.37}{100.37} ) = 6.27 \%$$

With ²H and ¹⁵N often ignored due to their low abundancy, the probability of M+1 peak if considering only ¹³C s:

$$5 \times ( \frac{1.11}{101.11} ) = 5.53 \%$$

### Example 2

In this Example, we describe a thin PIL-IL/GO selective layer on a bPES/PET substrate with well-interconnected pores as highly permeable FTM that demonstrates high performance of CO₂ separation from CO₂/N₂/O₂/H₂O mixture at extremely low CO₂ partial pressures. The impacts of oxygen and water on CO₂ capacity and the diffusivity of the carrier were examined by ¹³C-NMR and ¹H-DOSY NMR. The specific interactions between the GONF and the PIL-IL gel was characterized by HSBC NMR and FTIR. This example describes the CO₂/O₂ selectivity and tunability of the CO₂/(N₂+O₂) separation ratio, and the mechanical strength against a transmembrane pressure for PIL-IL/GO type FTMs through the modifications of the PIL-IL composition and GONF layer thickness.

### Experimental Section

### Materials

The IL precursor, 1-ethyl-3-methylimidazolium iodide ([EMIM][I], >98%) was purchased from TCI America. The ACS grade reagent methanol, isopropanol, and acetone were purchased from Alfa Aesar via Thermo Scientific. Anion precursor pyrrole-2-carbonitrile (99%) and Amberlite® IRN-78 anion exchange resin (AER) in [OH⁻] form were purchased from Thermo Scientific. The poly(ionic liquid) (PIL) precursor, poly (diallydimethylammonium chloride) (P[DADMA][Cl], M_{w} 400-500 kDa, ˜20 wt % aqueous solution) and paramagnetic compound chromium acetylacetonate (Cr(ACAC)₃, 97%) were purchased from Millipore-Sigma. The AER was washed with methanol for at least three times and vacuum dried at room temperature before use. Solid P[DADMA][Cl] was acquired by directly pulling vacuum on the aqueous solution at 40° C. for three days and 80° C. for a day. The deuterated solvent DMSO-d₆ (25 ml, 99.8%) was purchased from Thermo Scientific. The NMR tubes (5 mm OD; 7″ L; wall thickness: 0.38 mm) with coded closed caps were purchased from Bruker. The NMR coaxial tube set (inner cell: NE-5-CIC; outer cell: NE-UPE-7) were purchased from New Era Enterprises, Inc.

The ultrafiltration (UF) substrate membrane (LY; nominal cutoff of 100 kDa) with poly(ethersulfone) (PES) skin layer and poly(ethylene terephthalate) (PET) nonwoven substrate was purchased from Synder Filtration. The bPES/PET was prepared. Briefly, the highly gas permeable substrates with bicontinuous structured skin layer (with pore size of 30-40 nm) were fabricated by water-vapor induced phase separation, followed with water immersion. This highly permeable membrane is abbreviated as bPES/PET to make a dis-tinction from the commercial UF substrate. Single-layer graphene oxide (GO) dispersion (5 mg ml⁻¹) was purchased from ACS Material (synthesized by modified Hummers' method and have an average width and thickness of 0.3 μm and 0.8 nm, respectively).

Tank gases of nitrogen (N₂; Ultra High Purity (UHP)), argon (Ar; UHP), helium (He; UHP), carbon dioxide (CO₂; bone dry), hydrogen (H₂; UHP), and synthetic air (synthetic blend of N₂ (80%) and O₂ (20%), with less than 1 ppm of CO₂) were purchased from Airgas.

### Methods

Synthesis of [EMIM][2-CNpyr](IL) and P[DADMA][2-CNpyr](PIL). The synthesis of IL and PIL started with the anion exchange step of the precursor materials of [EMIM][I](10 g in 100 ml methanol) and P[DADMA][Cl](10 g in 100 ml methanol), respectively, into OH⁻ intermediates. The use of AER to precursor was monitored to be around 5 mg AER per mmole precursor. The residual halide content in the intermediate solution was tested by 0.1 N silver nitrate (AgNO₃) solution and confirmed to be low (<1000 ppm) from the lack of visual white precipitates of silver halides. The halide contents were further determined to be lower than 0.25% (detection limit) by combustion ion chromatography. The intermediate solutions of IL and PIL in [OH]⁻ form were separately mixed with the anion precursor pyrrole 2-carbonitrile (with cation to anion precursor molar ratio of 1:1.02 mol) for acid-base neutralization reaction to complete overnight. The excess solvent was removed from the resulting solutions by rotary evaporation at 60° C. Samples were then vacuum dried at 80° C. for overnight to remove residual water. The molecular structure of the synthesized PIL and IL were characterized and confirmed by ¹H-NMR and heteronuclear single quantum coherence (HSQC), heteronuclear multiple bond correlation (HMBC) on a Bruker 500 MHz.

### Fabrication of PIL-IL/GO Composite Membrane

Both UF and bPES/PET membrane substrates were rinsed with methanol/DI water (1:1, v/v) for at least three times to remove residual salt crystals from the substrate. This step is important as these contaminants can change the surface charge of GO flakes in the suspension in the next step, causing coagulation and failure of the GONF layer deposition. The membranes were dried in vacuum at 40° C. overnight prior to use. The GO in water dispersion (0.2 mg ml⁻¹ and 2 mg ml⁻¹) were prepared by diluting the purchased GO solution (5 mg ml⁻¹) with DI water and sonication. The GONF layer was deposited over the substrates by vacuum filtering the GO suspension on top of the membrane substrate (with level accuracy checked) for roughly 5-10 min. To ensure even coverage and a final GONFL layer with homogenous thickness, the leveling of the membrane was confirmed to be perfectly horizontal. The deposited GONF layer was then impregnated by the PIL-IL gel by drop casting. The PIL-IL casting solution was prepared by mixing 0.2 mg ml⁻¹ of PIL and 20 mg ml⁻¹ of IL in methanol. The fabricated PIL-IL/GO on bPES/PET membranes were allowed to dry under ambient air and were kept under vacuum at ambient temperature before use.

### Materials Characterization

The Fourier-Transformed Infrared (FTIR) spectra of the IL, PIL, and membranes were taken on Nicolet iS50 (Thermo Scientific) using a diamond crystal attenuated total reflectance (ATR) unit. Water content of the ILs were confirmed to be <1000 ppm by a coulometric Karl Fischer titrator (Metrohm; 889D). Viscosity of the IL was measured with a viscometer (RheoSense; microVisc) equipped with microchannel chips (Rheosense A05, A10, and B20). The phase transition of PIL-IL gels was performed with a DSC (Mettler Toledo DSC3), where the PIL-IL gels (˜ 15 mg) were pre-loaded into Al pans and sealed in Ar atmosphere glovebox (VTI; H₂O and O₂<0.1 ppm). The sample pans were first held at 80° C. (5 min), then cooled to −90° C. and held for 50 min, and finally heated back to 80° C. with a rate of 10° C. min⁻¹ under N₂ for three cycles. No differences were observed among the cycles and therefore only the glass transition temperature (T_{g}) of the third cycle is reported. The surface morphology and cross-sectional topography of the membranes were taken by field emission scanning electron microscopy (FESEM; ThermoFisher Apreo 2S). All membrane samples were sputtered with about 5 nm Pd prior to analysis for high conductivity and better image resolution.

### CO₂ Binding Capacity

The CO₂/N₂/O₂ gas mixture was prepared by mixing the CO₂ with the as-purchased synthetic air (N₂/O₂) by mass flow controllers (MFCs; Brooks 5850i) with Labview® via data acquisition units (DAQ; National Instrument 782604-01). The humidity control was achieved by a water bubbler. For the precise control of temperature, the gas lines, including the water bubbler, was kept inside an incubator (HettCube 400R; Across International LLC). The mixing of the gases for the desired compositions of 410, 1000, 2500, 5000, 10 000, and 20 000 ppm of CO₂ at 22° C. and 40% relative humidity level (40% RH at 22° C. refers to 7.9 Torr or 10.6 mbar) was done in a 300 mL metal chamber (Swagelok) within the incubator. The gas flow rate was measured by ADM 2000 Flowmeter (J&W Scientific Inc., acquired by Agilent). A CO₂ analyzer (SBA-5, PPSystems Inc.) with a detection range of 0 to 20 000 ppm was used to confirm the CO₂ concentration in the prepared gas mixtures. To determine the CO₂ absorption capacity of the IL, the gas mixture with the set CO₂ content (200 ml min⁻¹) was contacted with the IL (1 g) under 60 rpm agitation in a glass vial (20 ml) for at least 6 h at 22° C. for equilibrium. The equilibrium for CO₂ saturation was reached within 2-3 h, whereas the equilibrium for the set relative humidity took longer. Therefore, a wait time of 6 h was allowed to ensure the system reached thermodynamic equilibrium. The binding capacity between CO₂ and IL carrier was studied by quantitative ¹³C-NMR. Following CO₂ absorption, 20 mg of the IL was sampled into 0.6 ml of 0.1 M Cr(ACAC)₃ DMSO-d₆ solvent and quantification of the CO₂—IL complex followed the previously reported method. The identified products were identical to our previous report; briefly the peaks at 146, 154, and 158 ppm were assigned to carbamate, carboxylate, and bicarbonate complexes, respectively.

### Self-Ion Diffusivities

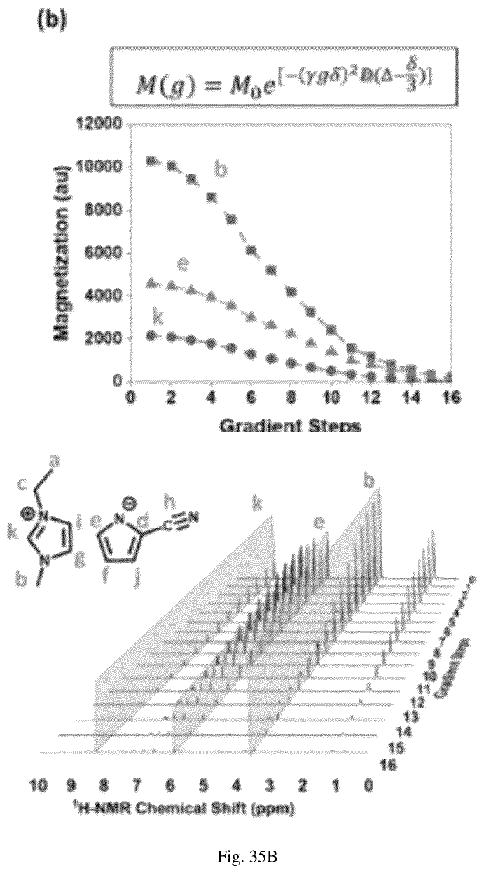

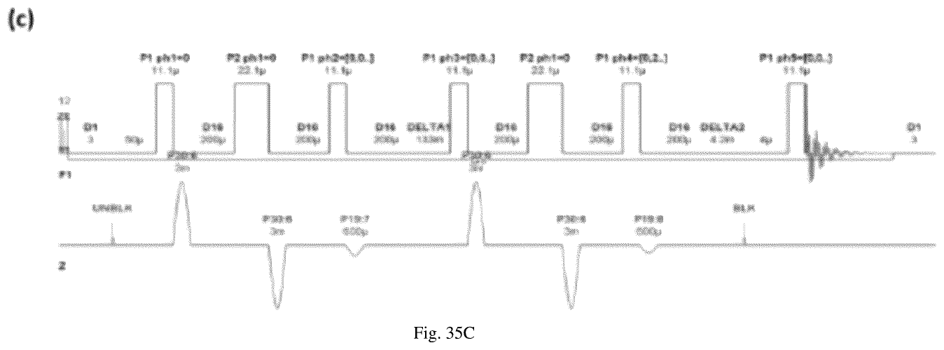

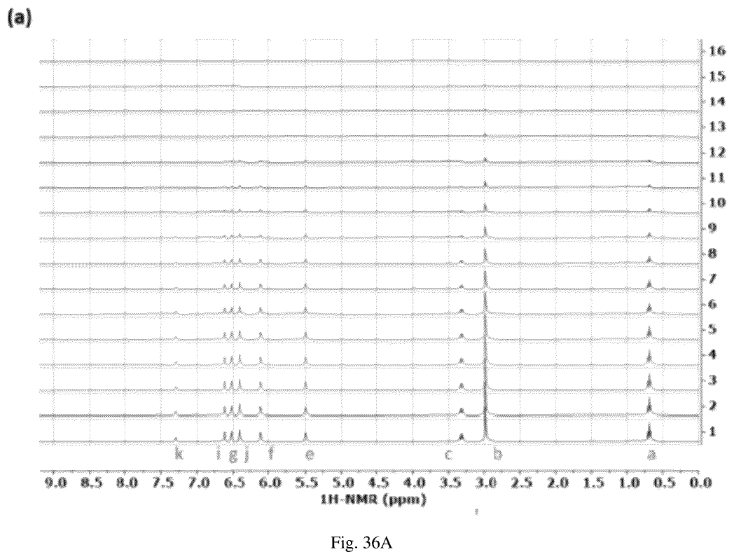

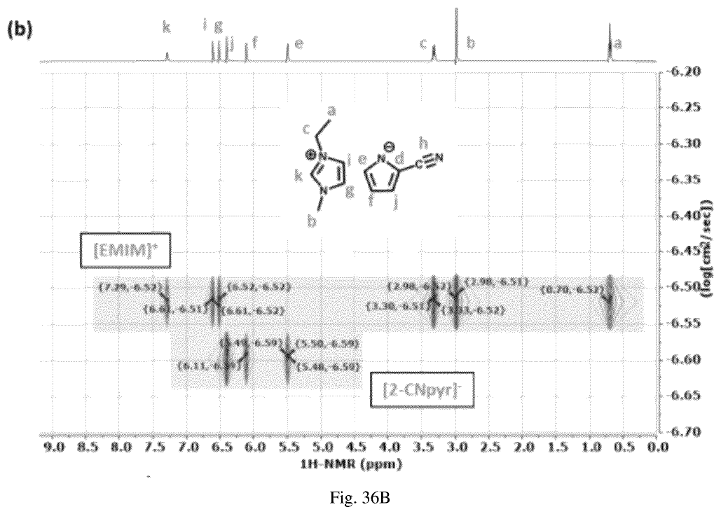

Self-diffusion coefficient of the IL was measured by Diffusion-Ordered Spectroscopy (DOSY) on the same 500 MHz NMR. About 0.3 ml of DMSO-d₆ was loaded into the inner cell and the top was flame sealed (or sealed with epoxy resin). About 1.5 ml of the C02-saturated IL (at 410, 1000, 2500, 5000, 10 000, and 20 000 ppm CO₂ under 40% RH) was transferred into the outer cell and the atmosphere in the headspace was purged with the same atmosphere used for CO₂ absorption. The inner cell was then inserted into the outer cell and sealed with coded close cap and parafilm to ensure a gas tight environment. The samples were measured using bipolar gradient pulse sequence (ledbpg2s) and the Z-gradient diffusion probe (FIG. 35A). The diffusion times (A) and gradient pulse duration (6) were optimized in subsequent experiments according to practical needs, until full exponential decay pattern of magnetization was observed within 16 pulse gradient strengths (from 2% to 98%) (FIGS. 35B and 36A). The isotopic self-diffusivity (D) of ions was calculated using eqn (1)via MestReNova.

$$M ( g ) = {M}_{0} {e}^{[ \text{?} ]} \qquad ( 1 )$$

$$\text{?} \text{indicates text missing or illegible when filed}$$

where γ is the gyromagnetic ratio, g is the magnitude of the gradient pulse, 6 is the duration of the gradient pulse, and Δ is the interval (drifting or diffusion time) between two gradient pulses in the opposite direction. M₀ is the strength of magnetization without pulse field gradient applied, whereas M(g) is the measured magnetization that exponentially decay as a function of applied pulse field gradient strength. An example of the calculated ¹H-DOSY is shown in FIG. 36B.

### Membrane Tests

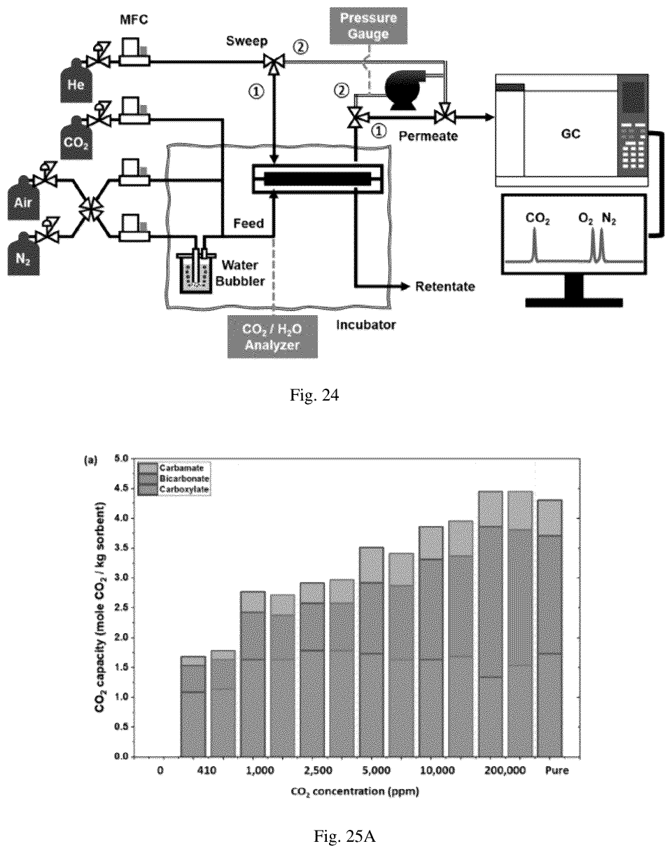

The gas separation performance of the PIL-IL/GO composite membrane was tested under both sweep and vacuum modes. The membrane was placed in between two aluminum foils and fastened in a stainless-steel permeation cell (Advantec). The membrane module along with the bubbler and gas mixing chamber were kept within the temperature and humidity-controlled incubator (HettCube 400R; Across International LLC). Simulated CO₂/N₂/O₂/H₂O feed gas of 410, 1000, 2500, 5000, and 10 000 ppm CO₂ with various humidity level were prepared by fine tuning the gas flow rate of the anhydrous CO₂, anhydrous synthetic air (N₂/O₂=80/20), and moisture saturation by passing the specific gas streams through the water bubbler. The CO₂/N₂/H₂O feed gas were prepared by mixing anhydrous CO, anhydrous N₂, and moisture saturated N₂. FIG. 24 shows the schematic of the membrane testing setup. The permeate side of the membrane module has both the helium sweep (0 Torr gauge pressure; single solid line) and the vacuum (−760 Torr gauge pressure; double solid line) capability for testing of different transmembrane pressures. The flow rate of feed gas and sweep gas were kept constant as 200 cm³ min⁻¹. For tests under the sweeping mode (labeled with pathway \textcircled{1} in FIG. 24), the permeate gas was carried by the He sweep directly to a gas chromatography, GC (Agilent 7890B) with a micro-packed column and thermal conductivity detector (TCD) with He mobile phase for quantitative compositional analysis. For tests under vacuum operation (labeled with pathway \textcircled{2} in FIG. 24), the permeate was first collected by a pump (Agilent; IDP-7 dry scroll pump) under vacuum and then mixed with the He sweep, as shown, for GC analysis. The specific testing conditions are listed in Table 2.

TABLE 2
Fabricated FTM specifications and
the membrane testing conditions

| | | | | | |
|---|---|---|---|---|---|
| Membrane # | i | ii | iii | iv | v |

Membrane substrate

| | | |
|---|---|---|
| Substrate | UF | bPES/PET |

| | |
|---|---|
| Membrane area | 5 cm² |

Selective layer

| | | | | |
|---|---|---|---|---|
| PIL-IL/GO | 0.2-20/0.2 | 0.4-40/0.4 | 0.5-50/0.5 | 1.25-3.75/1 |
| (mg-mg/mg) | | | | |
| Thickness (μm) | 0.9 | 1.4 | 1.6 | 2.0 |

Membrane testing condition

| Feed; sweep | 200 cm³ min⁻¹; 200 cm³/min | |
|---|---|---|
| CO₂ in feed | 410, 2500, and 10 000 (1%), CO₂ balanced with | |
| (ppm) | N₂ or synthetic air (N₂/O₂ = 80/20) at 760 Torr | |
| Transmembrane | 0 | 760 |
| pressure (ΔP; Torr) | | |
| Temperature (K) | 295 and 313 K | |
| Relative humidity | 0, 40, and 80 | 40 |
| (% RH) | | |

The gas separation performance was calculated in gas permeance unit (GPU; 1 GPU=3.348×10⁻¹⁰ mol m⁻² s⁻¹ Pa⁻¹) by eqn (2). Pᵢ=10⁶(Qᵢ/(A·Δpᵢ)) (2) where Qᵢ is the permeating rate of component i (cm³ s⁻¹), A is the membrane area (5.06 cm²), and Δpᵢ is the transmembrane partial pressure gradient for component i (cmHg). The uncertainty in permeance (Pᵢ) was determined from the propagation of error analysis using the respective uncertainties in A (±0.11 cm² based on the measured membrane coupon radius of 0.2 mm), Δpᵢ(±0.01 cmHg based on the measured concentrations by GC) and the standard deviation in the repeated measurements for Qᵢ (varied for each of the conditions in the range of 0.0001-0.0003 cm³ s⁻¹ for 5 measurements).

The selectivity of CO₂ over N₂ (α_{CO2/N2}) and CO₂ over O₂ (α_{CO2/O2)} are calculated using eqn (3) and (4), respectively. The separation ratio (α_{CO2/(N2+O2)}), which is the permeance ratio of CO₂ over the sum of N₂ and O₂, is a parameter that better describes the performance of gas separation in ternary gas mixtures, and it is calculated using eqn (5).

$${α}_{CO \text{?} N \text{?}} = \frac{{P}_{CO \text{?}}}{{P}_{N \text{?}}} \qquad ( 3 )$$

$${α}_{CO \text{?} O \text{?}} = \frac{{P}_{CO \text{?}}}{{P}_{O \text{?}}} \qquad ( 4 )$$

$${α}_{CO \text{?} ( N \text{?} O \text{?} )} = \frac{{P}_{CO \text{?}}}{{P}_{N \text{?}} + {P}_{O \text{?}}} \qquad ( 5 )$$

$$\text{?} \text{indicates text missing or illegible when filed}$$

The dependence of CO₂ permeance on the CO₂ partial pressure of the feed is described by a homogenous reactive diffusion model given in eqn (6).

$$\frac{{P}_{CO \text{?}}}{l} = \frac{{P}_{CO} \text{?}}{l} [ 1 + {η}_{CO \text{?}} ( \sqrt{1 + \frac{{p}_{CO} \text{?}}{{p}_{CO} \text{?}}} - 1 ) ] \qquad ( 6 )$$

$$\text{?} \text{indicates text missing or illegible when filed}$$

where l is the thickness of the membrane, P_{CO2}/l is the measured CO₂ permeance, P_{CO}_{_{2*/l is a fit parameter that represent the CO}}₂ permeance (GPU) at saturation of carriers (corresponding to the CO₂ permeance from S-D pathway), η_{CO2} is the efficacy of the facilitated transport pathway, p_{CO}_{₂}* is the partial pressure of CO₂ in the feed when the carriers are saturated with CO₂, and p_{CO}_{₂}^{b} is the set CO₂ partial pressure in the feed.

### Results and Discussion

We first present the results from the characterization of the CO₂ carrier, namely the [EMIM][2-CNpyr], in terms of its CO₂ binding capacity in the presence of N₂ and O₂, measurement of ion self-diffusivities, and the thermal behavior of the IL when gelled with PIL. The fabricated membranes with the PIL-IL gel is then described through their topological and cross-sectional features as determined by SEM as well as the specific interactions among the PIL, IL, and GO components examined by FTIR and NMR methods. Finally, the CO₂ separation performance of the FTMs under synthetic air feed and at varying temperature and humidity conditions are presented.

### CO₂ Binding and Transport

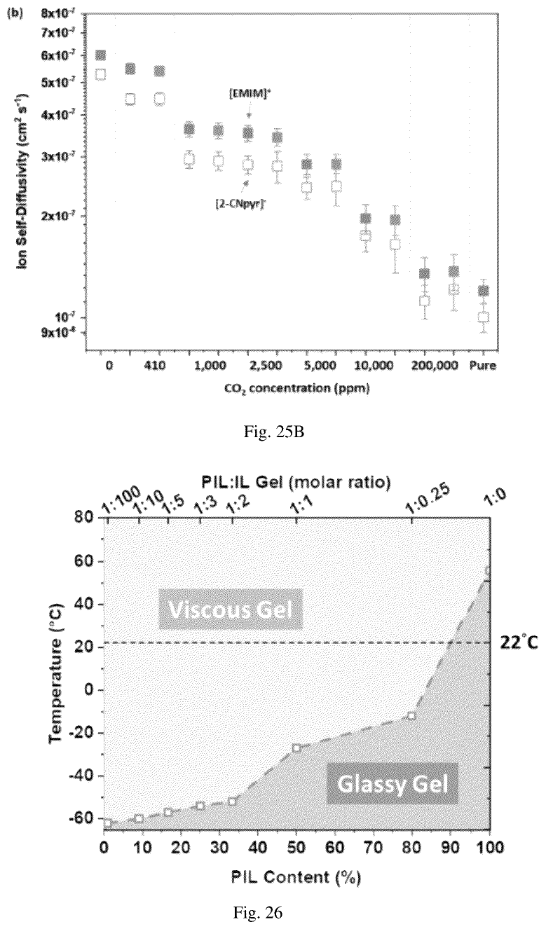

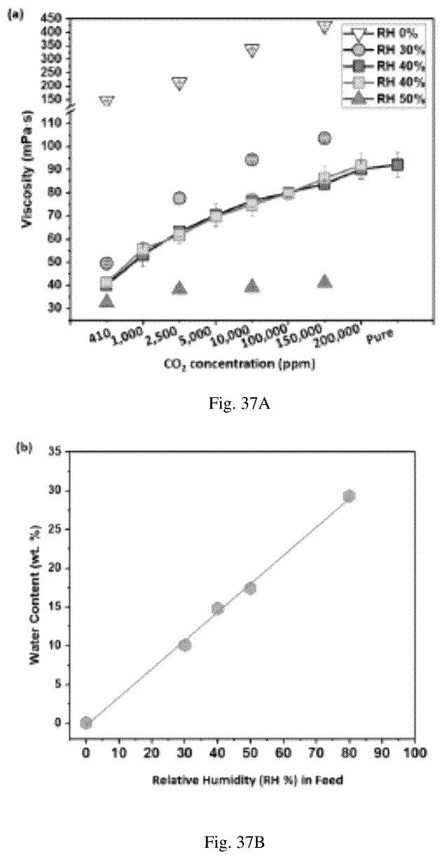

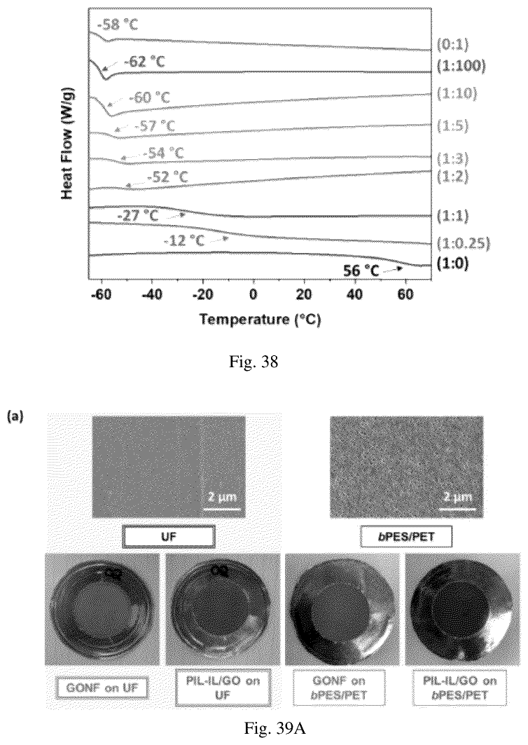

CO₂ binding to the IL and the ion diffusivities in the presence of O₂ (16-20%) is studied at 22° C. and 40% RH (10.6 mbar). The CO₂ absorption by [EMIM][2-CNpyr]has been previously shown form carbamate (CO₂ binding to the pyrrole anion), carboxylate (CO₂ binding to the imidazolium cation), and bicarbonate (CO₂ binding to the co-absorbed water) species in both pure CO₂ and CO₂/N₂ mixture gas. The distribution of these products was found to be different at low CO₂ partial pressures in CO₂/N₂ compared to pure CO₂. FIG. 25A shows the breakdown of the measured CO₂ binding capacities, calculated from the ¹³C-NMR peak integration of carbamate at 146 ppm (—N—COO), carboxylate at 154 ppm, and bicarbonate (HO—COO) with (red bordered) and without O₂ presence (black bordered). At 410 ppm, 40% of the total capacity under pure CO₂ is achieved in both cases of with and without O₂, showing the strong interactions between the IL and CO₂. The capacity at 2500 ppm of CO₂ is about 60% of the total capacity under pure CO₂ (4.3 mole CO₂ per kg sorbent). Within the gas compositions studied, there is no significant influence of O₂ on the measured solubility of CO₂. The physisorbed of CO₂ within the entropic voids of the [EMIM][2-CNpyr] is expected to be less than 3% of the overall CO₂ solubility. The physiosorbed O₂ is expected to be at least a factor lower than that of physiosorbed CO₂ in ILs in general. This is due to the high polarizability of the quadrupolar CO₂ within ionic environments, in contrast to nonpolar O₂. The measured bulk viscosity of the IL is also not influenced much with O₂ (FIG. 37A). However, as seen in FIG. 25B, the measured ideal diffusivities of the imidazolium cation (filled symbols) and the pyrrolide anion(hollow symbols) demonstrate a weak dependence on 02 (3-5% difference between gray and red symbols) and a strong dependence on CO₂.

The ion self-diffusivities were measured by ¹H-DOSY NMR (FIG. 36). The diffusivity of imidazolium (D⁺) is higher than the pyrrolide (D⁻) despite the smaller size of the pyrrolide anion. Previous studies on various ILs reported similar observations and attributed this trend to the hydrogen bonding associated mostly with the anions. The diffusivity of [EMIM], [2-CNpyr], and their CO₂-complexes are around 10⁻⁷ cm² s⁻¹ at 22° C., which is an order of magnitude higher than the reported ion diffusivities for a similar CO₂ reactive IL 1-methyl-3-ethylimidazolium acetate (˜10⁻⁸ cm² s⁻¹ with a viscosity of 2700 cP). The CO₂-complexed ions could not be resolved effectively from their parent ions as they appeared as single peak for both the imidazolium and the pyrrolide. This is attributed to the strong H-bonding between the CO₂ complexed and un-complexed ions and the fast exchange of proton between these species. The strong dependence of the ideal diffusivity of both the cation (D⁺) and the anion (D⁻) on the quantity of CO₂ within the IL is also indicative of the increased intermolecular hydrogen bonding that leads to slower diffusion. It should be noted that the direct deconvolution of different transport mechanism of CO₂ (diffusion, hoping, and vehicular motion) is not possible at this point by ¹H-DOSY since CO₂ itself is not proton-bearing. Therefore, the measured diffusivities of ions reflect the overall transport of carrier-CO₂ complex. The (D⁺/D⁻) ratio remained in the range of 1.18-1.23 for all of the conditions studied, suggesting no major changes in the solvation environment when O₂ is present in the carrier liquid.

The incorporation of PIL into IL provides mechanical reinforcement by forming a non-crosslinked gel. In turn, the IL component acts as the plasticizer for mobility enhancement of the CO₂ carrier. FIG. 26 shows the phase-transition of PIL-IL gels in the bulk as characterized by DSC. The plotted red squares are the glass transition temperatures (T_{g}) of the PIL-IL gels, as determined from the midpoint of the transition region of the DSC curves. The T_{g} decreases as the amount of PIL decreases. In order to have a mobile carrier within the membrane at cabin or atmospheric temperatures, it is more desirable to have a viscous gel than a glassy one. Therefore, optimization of the PIL-IL content is necessary for a targeted permeance. Too high of a PIL content would increase the membrane resistance while too high of an IL content may not demonstrate sufficient mechanical stability against large transmembrane pressures. We tested the PIL:IL composition of 1:100, similar to our previous work, to allow for high carrier mobility, for the sweeping mode of operation and the 1:3 PIL:IL composition to improve stability of the carrier within the membrane architecture against vacuum mode of operation on the permeate side.

### Characterization of PIL-IL/GO Membrane

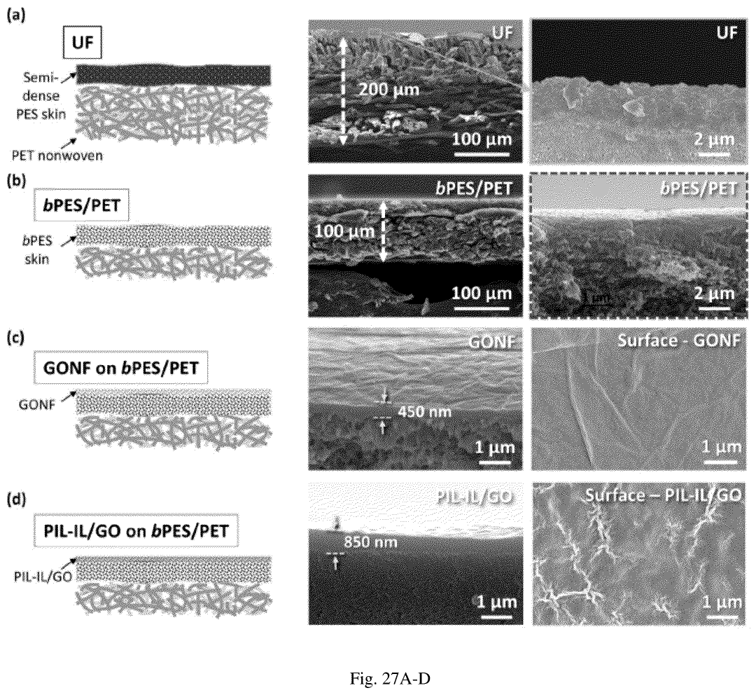

In comparison to the commercial UF membrane substrate (FIG. 27A), the schematics and the SEM images of bPES/PET substrate are shown in FIG. 27B. The bPES skin layer has an interconnected porous structure with a pore size of roughly 30-40 nm (FIG. 27B, right panel) whereas the UF substrate has a semi-dense PES skin layer (FIG. 27A, right panel). The fabrication of GONF on the bPES/PET substrate was done by vacuum filtering where the GO nanosheets (each with about 0.3 m width) were deposited homogeneously to give a wrinkled top surface (FIG. 27C, right panel). The deposited GONF is estimated to consist of about 250 to 260 GO layers, based on the individual sheet thickness of 0.8 nm and spacing of 1 nm in between the GO layers. The impregnation of the PIL-IL gel into the GONF layer caused swelling and change in surface morphology with a final PIL-IL/GO selective layer thickness of about 850 nm (FIG. 27D) in comparison to GONF thickness of about 450 nm (FIG. 27D).

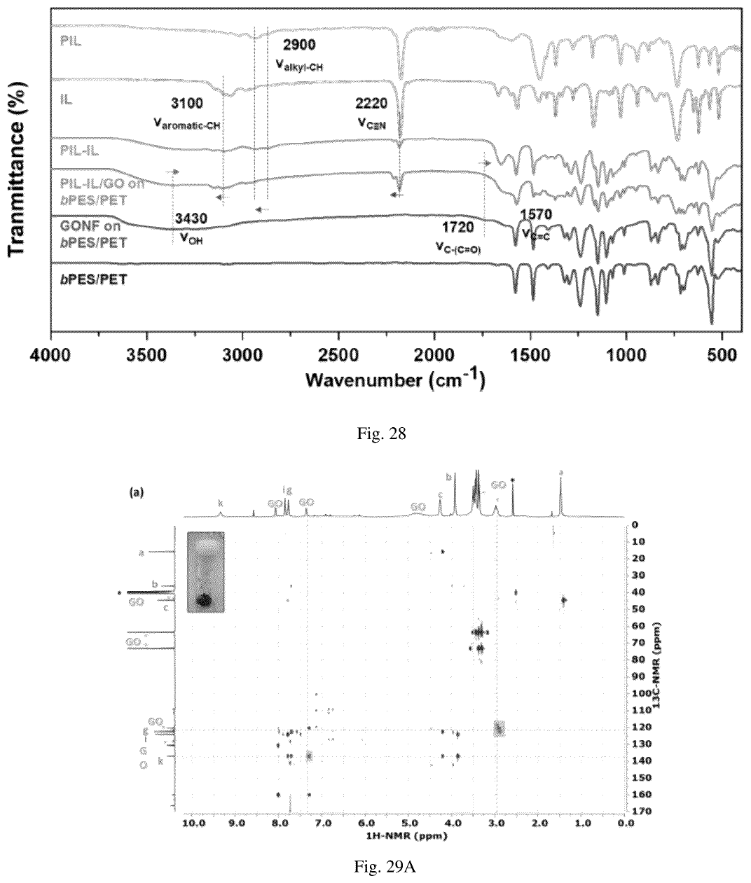

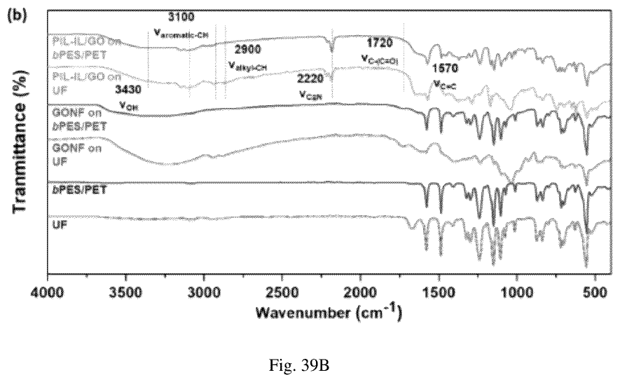

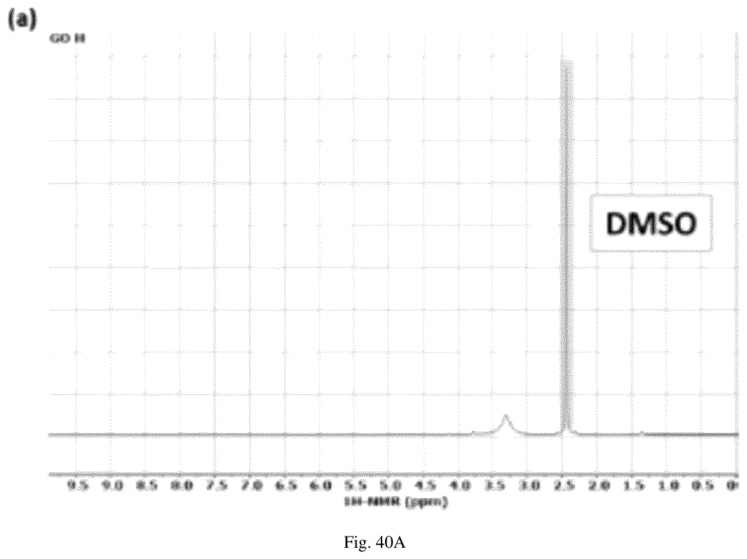

The specific interactions between GO and PIL-IL gel were probed by FTIR and NMR methods. FIG. 28 shows the FTIR spectra of PIL-IL/GO on bPES/PET substrate (ii in Table 2), where the characteristic features of PIL-IL (v_{aromatic-CH} 3100 cm⁻¹, v_{alkyl-CH} 2900 cm⁻¹, and v_{C≡N} 2220 cm⁻¹) and GO (v_{OH} 3430 cm⁻¹, v_{C—(C═O)} 1720 cm⁻¹, and v_{C═C} 1570 cm⁻¹) were confirmed. The observation of the red-shifted GO peaks (v_{OH} 3430 cm⁻¹ and v_{C—(C═O)} 1720 cm⁻¹; highlighted with red arrows) and the blue-shifted PIL-IL peaks (v_{aromatic-CH} 3100 cm, v_{alkyl-CH} 2900 cm⁻¹, and v_{C≡N} 2220 cm⁻¹; highlighted with blue arrows) suggest the molecular interactions between the PIL, IL, and GO components. FIG. 39B compares the peak shifts of the PIL-IL/GO on UF and bPES/PET substrate, in which we don't see much difference in the featured characteristic peaks. Therefore, we concluded that the nano-confinement of PIL-IL in GONF is effective, and the PIL-IL gel is not leached out into the substrate even when the pore size increase from UF (3-4 nm) to bPPES/PET (30-40 nm). The photo images of the PIL-IL/GO and GONF on UF and bPES/PET substrates are in FIG. 39A.

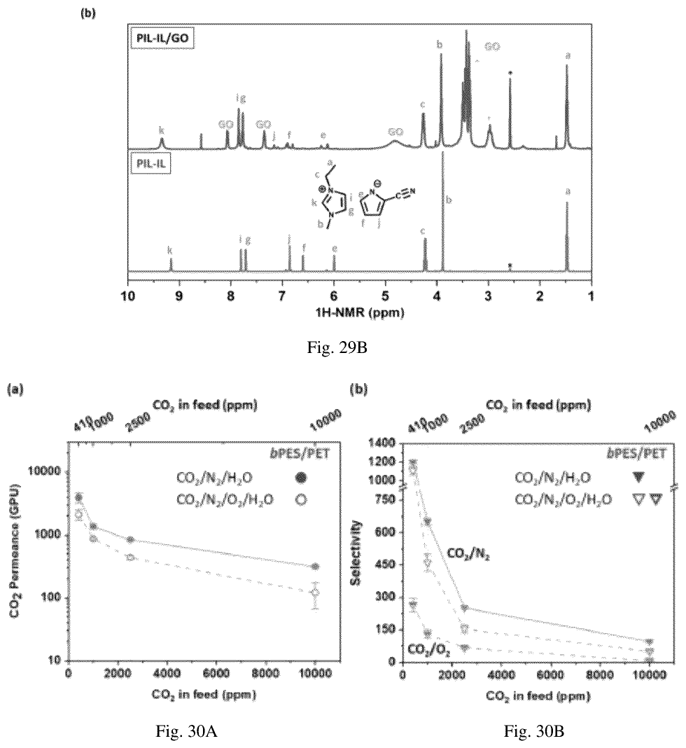

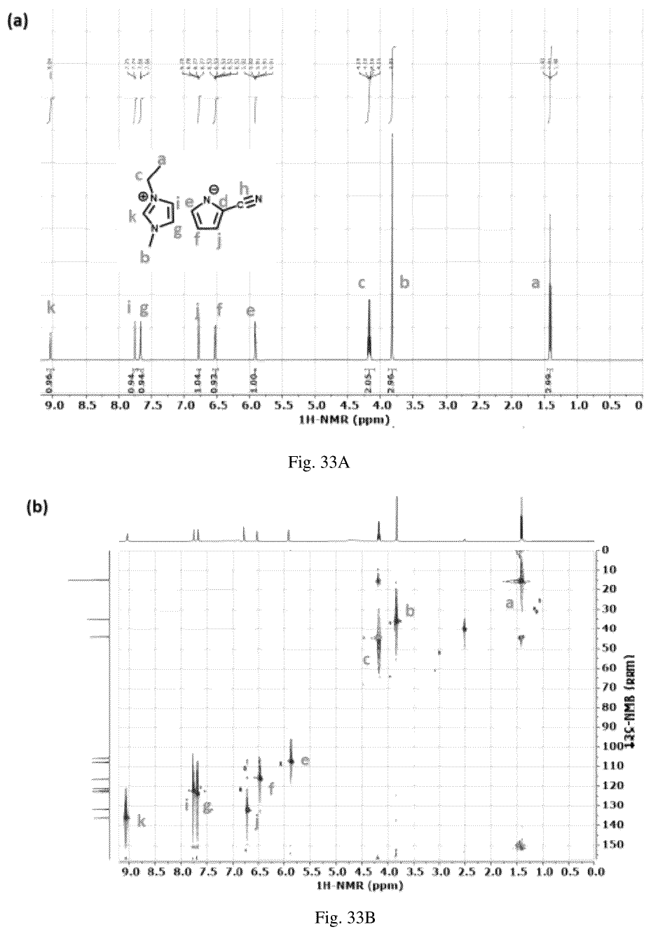

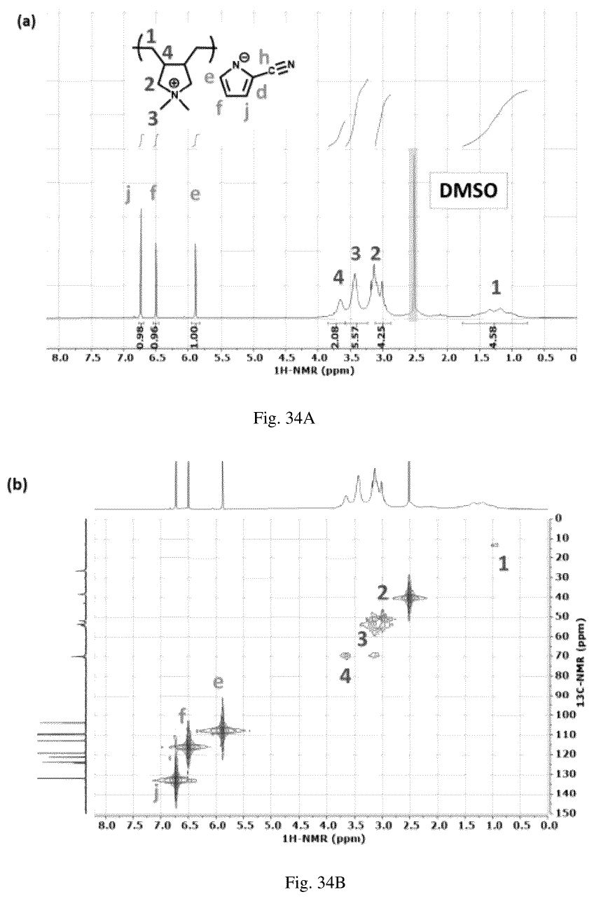

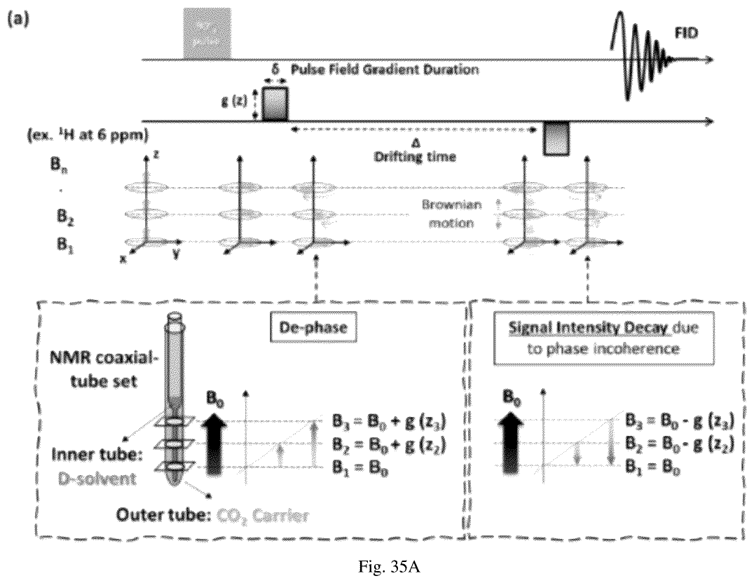

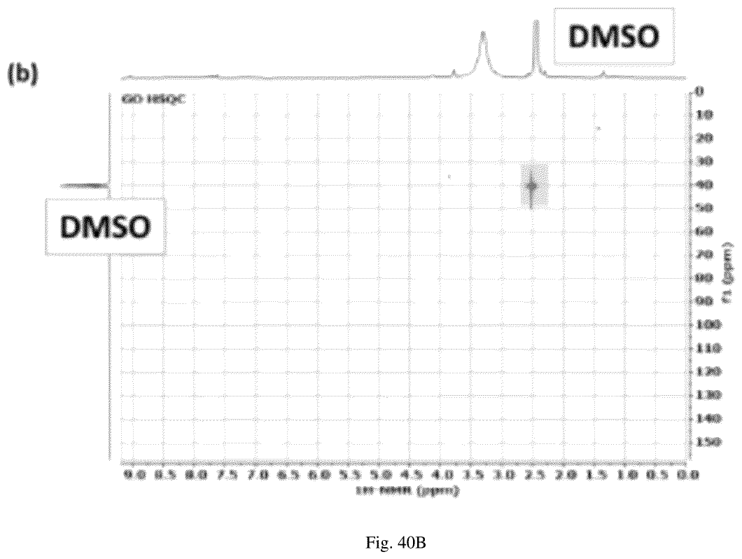

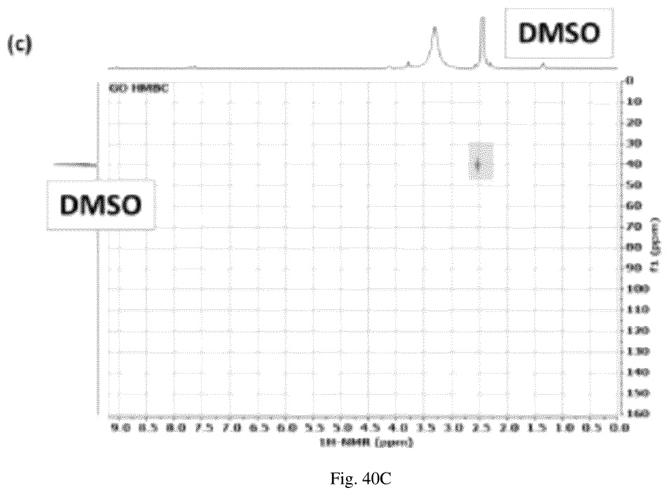

The HMBC NMR (FIG. 29A) further provided support to the interactions between the PIL-IL and GO by FTIR by specifically probing the correlated ¹H and ¹³C within the selective layer components. In order to remove the interference from the majority component, which is the substrate, the PIL-IL/GO flakes (FIG. 29A, inset) were scraped from the membrane surface and re-dissolved in DMSO-d₆ for HMBC. The correlations between the imidazolium ring (g, i, and k) and GO were highlighted in yellow at the intersections of the dashed lines (FIG. 29A). This interaction between [EMIM]⁺ and GO is ascribed to both the π-π and electrostatic interactions. Moreover, ¹H-NMR of PIL-IL/GO also suggests the interaction between PIL-IL and GONF. FIG. 29B compares the ¹H-NMR of PIL-IL/GO and PIL-IL gel. With a molar ratio of PIL:IL=1:100, we observed the spectra to be almost the same as IL (FIG. 33A) since the proton signal of PIL is diminished due to its low concentration (FIG. 29B, bottom). With the confinement of PIL-IL within the GONF, the characteristic peaks of [EMIM]⁺ cation “a, b, c, g, i, and k” broaden due to the relatively slow movement of the ions within the NMR time scale (FIG. 29B, top). Such broadening effect was observed only in the IL constituent and was not observed on the line width of the d-solvent (DMSO-d₆ at 2.58 ppm, labeled with *). The OH moiety of GO component is also downshifted to 4.7 ppm (FIG. 29B, top) from 3.4 ppm that is seen in pure GO sample without the presence of PIL or IL (FIG. 40). This shift further supports the existence of interactions between the PIL-IL and GO.

### CO₂ Separation

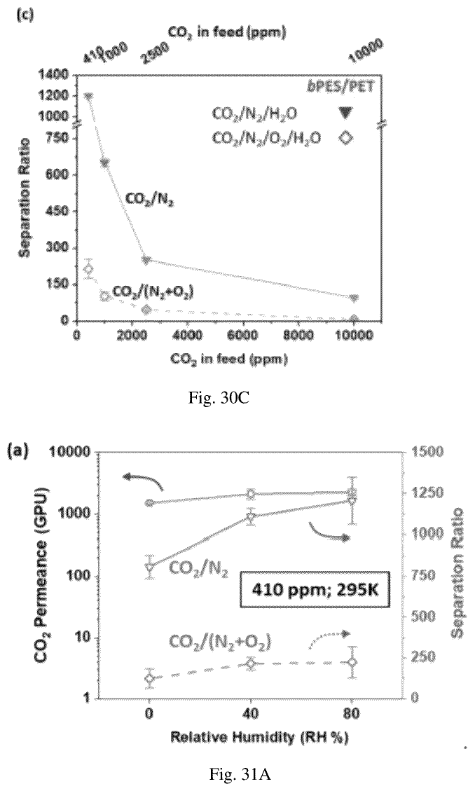

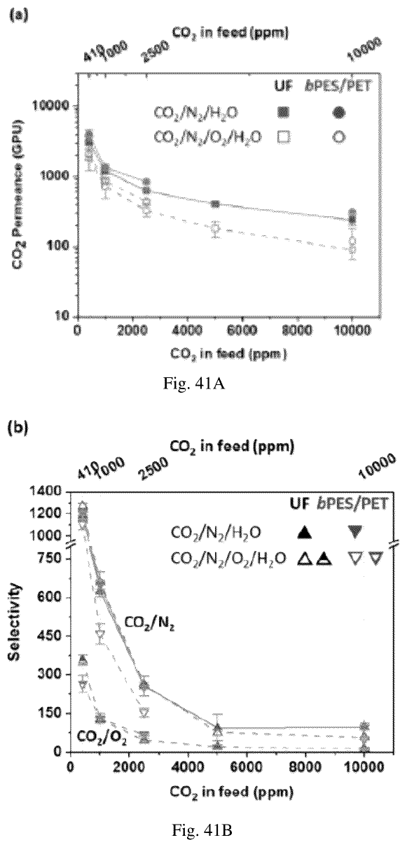

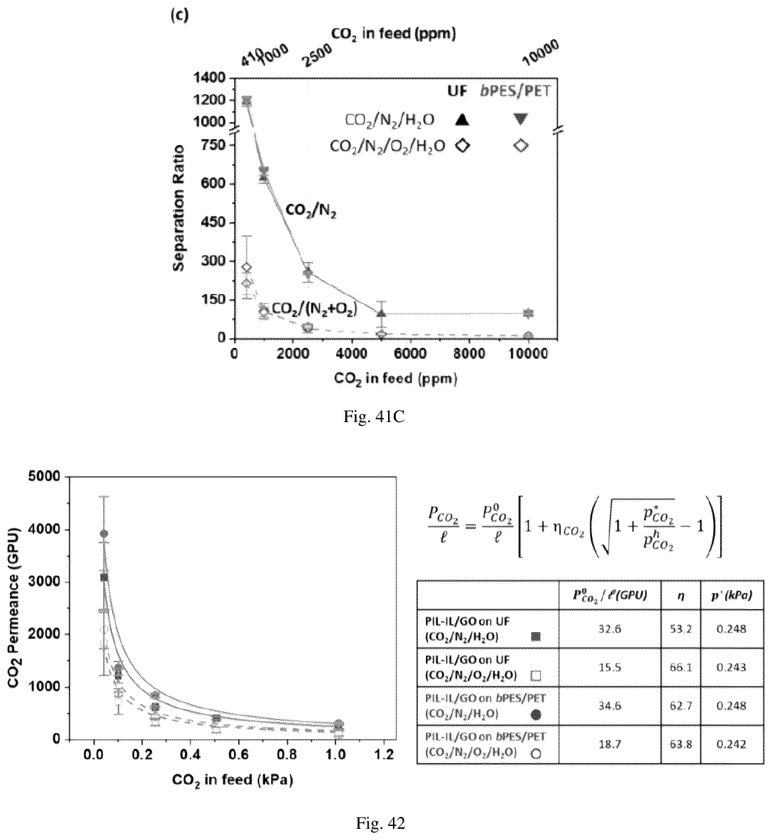

The CO₂ permeance and CO₂ selectivity against N₂ and 02 with the PIL-IL/GO FTMs were measured by membrane testing according to the conditions summarized in Table 2. FIG. 30 shows the performance of PIL-IL/GO on bPES/PET substrate (ii in Table 2); both with (hollowed symbols) and without 02 (filled symbols). CO₂ permeance of 3900 GPU (FIG. 30A) and CO₂/N₂ selectivity of 1200 (FIG. 30B) were measured under 410 ppm CO₂ with CO₂/N₂/H₂O mixture feed at 40% RH and 22° C. Under 2500 ppm CO₂ (cabin air), the performance was 1360 GPU with a CO₂/N₂ selectivity of 650. The exponential decrease in CO₂ permeance with increased CO₂ concentration in feed is a characteristic trait of facilitated transport (F-T) mechanism. The permeances for the non-reactive O₂ and N₂ stay constant around 6 GPU for O₂ and 1 GPU for N₂. The F-T pathway dominates over S-D mechanism for CO₂ transport at these low partial pressure conditions. While the CO₂/N₂ selectivity of the FTM with bPES/PET substrate (ii in Table 2) was about the same as the one with the UF substrate (i in Table 2; FIG. 41B†), PIL-IL/GO on bPES/PET presented 10% higher CO₂ permeance under both DAC and cabin air conditions with CO₂/N₂/H₂O mixture feed (FIG. 41A). Following the resistance-in-series model, this increase in permeance is ascribed to the thinner bPES skin layer with larger pore size (30-40 nm) that is interconnected as opposed to the semi-dense PES layer (pore size 3-4 nm) of the commercial UF substrate. The CO₂ permeance decreased by about 45% in the presence of O₂ to 2100 GPU at 410 ppm of CO₂ (FIG. 30A). This was observed irrespective of the substrate used (FIG. 41A†). Recalling that the solubility of CO₂ in IL is barely changed with and without the presence of O₂ presence (FIG. 25A), we suggest that the decrease in CO₂ permeance is related with the slower diffusion of CO₂ and CO₂-complexes within the membrane (FIG. 25B). The CO₂/O₂ selectivity (265 at 410 ppm CO₂) is lower than that of CO₂/N₂ selectivity (1100) since O₂ (˜5 GPU) is in general more permeable than N₂ (˜1.5 GPU), mainly due to their difference in molecular size (O₂: 3.46 ∀ vs. N₂: 3.64 ∀). FIG. 30C shows the separation ratio of PIL-IL/GO on bPES/PET with and without O₂. The PIL-IL/GO on bPES/PET was observed to have lower separation ratio due to the higher permeance of O₂ than N₂.

The experimental data presented in FIG. 30A was fitted to the facilitated transport model (eqn (6)) to extract parameters of P_{CO}_{₂}* and P_{CO}_{₂}* (FIG. 42t). The P_{CO}_{_{2*/l a parameter (in units of GPU) corresponds to the CO}}₂ permeance of FTMs at complete carrier saturation and therefore represents the S-D portion of the overall CO₂ permeance. The fitted values of P_{CO}_{_{2*/l are magnitudes lower than the overall measured CO}}₂ permeance P_{CO}_{_{2*/l; consistent with FTM behavior where CO}}₂ permeance decreases with increasing CO₂ concentration since the membrane starts to behave more like S-D membrane or even as a membrane absorber at high CO₂ partial pressures. The extracted CO₂ permeance at carrier saturation of the PIL-IL/GO on UF under CO₂/N₂ is 32.6 GPU, which is in the vicinity of the previously reported CO₂ permeance of 19 GPU at higher CO₂ concentration of 15% at 22° C. Further comparing the extracted value of P_{CO}_{₂}* (FIG. 42 inset table) under the condition with and without O₂, CO₂ saturation of carriers within the membrane seems more likely to happen when there is O₂ present, regardless of the membrane substrate used. The slower ion-self diffusivity in the presence of O₂ as seen in FIG. 25B also supports this observation.

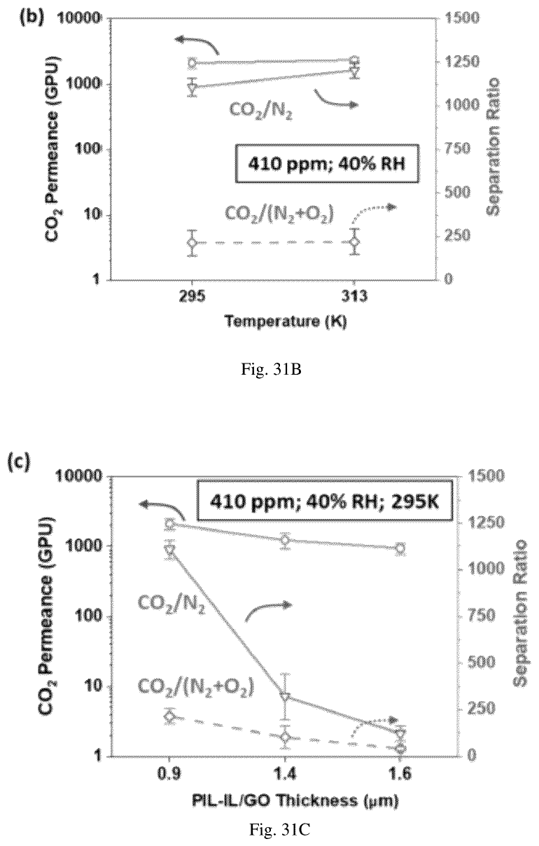

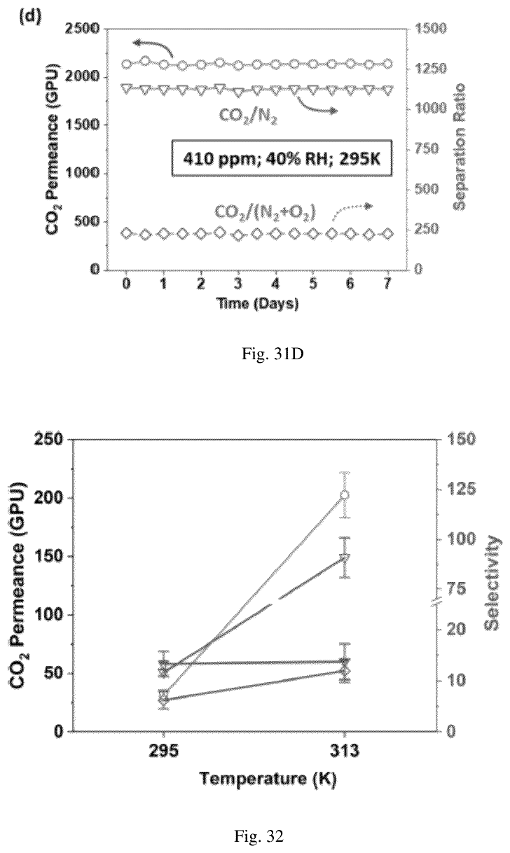

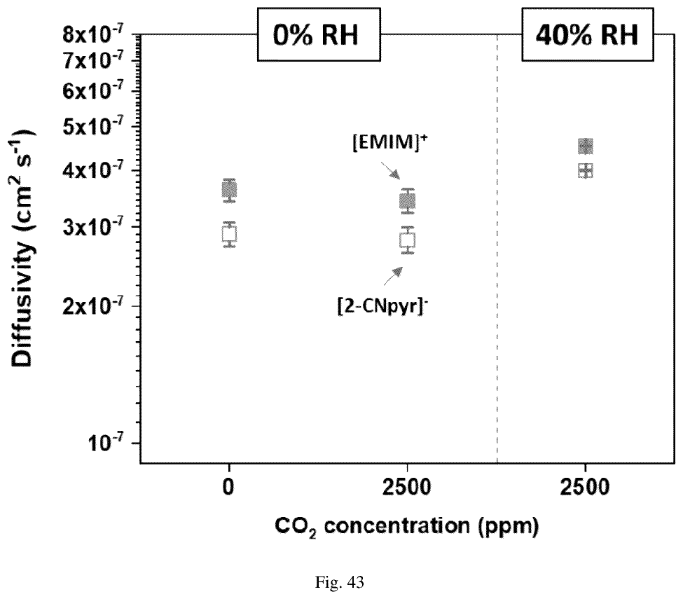

Factors like humidity and temperature are known to influence the transport behavior in FTMs. Under high humidity, water is co-absorbed with CO₂. The presence of water is known to decrease the viscosity of ILs and it also increases the CO₂ capacity due to the reaction between CO₂ and water that forms bicarbonate. On the other hand, increase in temperature not only increases chain mobility in PIL (hence faster CO₂ transport) but also encourages the dissociation of IL-CO₂ complex (hence faster CO₂ release) due to the exothermic nature of CO₂ absorption. Therefore, CO₂ separation from air for PIL-IL/GO on bPES/PET was evaluated at different humidity levels and temperatures as shown in FIGS. 31A and B, respectively. The CO₂ permeance, CO₂/N₂ selectivity, and separation ratio all increase with increased humidity and temperature, primarily owing to the faster transport of the CO₂. A higher CO₂ transport was achieved with higher moisture content, since humidity not only increases the binding of CO₂ to IL carrier (via greater extent of bicarbonate formation) but also increases the diffusivity of the carriers due to lubrication effect from water co-absorption (FIG. 43). With increased temperature, CO₂ and IL-CO₂ complex diffusivities are expected to increase, so does the dissociation rate of IL-CO₂ complex. There is much discussion in the field on whether it is the increase of the carrier mobility or the CO₂ dissociation rate that dominates for higher CO₂ separation performance with increased temperature. A recent study on high performance FTMs at room temperature suggest the rate determining step is the diffusion. Therefore, not surprisingly the separation performance decayed with increased thickness of selective layer (from ii to iv in Table 2) as seen in FIG. 31C due to the increased film resistance to diffusion. FIG. 31D further demonstrates the stability of PIL-IL/GO on bPES/PET over the course of 7 days under continuous feed of 410 ppm CO₂ at 40% RH and 295 K. We believe that the nano-confinement of PIL-IL within GONF (through (1) π-π interaction and (2) electrostatic interactions) played a pivotal role for this stability.

We further tested PIL-IL/GO on bPES/PET under vacuum operation with 760 Torr transmembrane pressure. Membranes ii, iii, and iv (in Table 2) leaked. We noticed the transmembrane pressure gradient could not be maintained and the permeate composition was almost the same as the feed, suggesting the need of further mechanical reinforcement on the selective PIL-IL/GO layer. Table 3 shows our efforts of changing the PIL-IL/GO composition by gradually increasing the PIL and GO loading of the selective layer. The increase of PIL and GO components increased the mechanical stability of the PIL-IL/GO; however, this was accompanied with significant reductions in CO₂ binding capacity and transport. The high content of PIL also led to a relative brittle film (see FIG. 26) where cracks could form even under the plasticization by moisture at 40% RH (i.e., samples 3 and 7 in Table 3). However, it was demonstrated that a PIL-IL/GO of 1.27-3.75/1 (v in Table 2; sample 21 in Table 3) withstands the pressure gradient. FIG. 32 shows CO₂ separation performance at 295 and 313 K for the FTM sample v. At 295 K, the F-T pathway appears to be more hindered due to the higher PIL content, which is less reactive to CO₂ without the imidazolium moiety in the ionomer structure, and the thicker selective layer. The performance resembles an S-D membrane, where a CO₂ permeance of 31 GPU and separation ratio of 6.2 were measured. At 313 K, the F-T mechanism was enhanced due to improved diffusivity with increased temperature, the CO₂ permeance increased by 15-fold along with an increase in CO₂/N₂ selectivity. However, the C02/O₂ selectivity remains about the same, possibly due to the enhanced 02 diffusion. These results demonstrate that even a relatively small increase in the thickness of the selective layer for mechanical stability results in dramatic reduction in the FTM performance, thus identifying the mass transport resistance as the most critical factor. Therefore, our recommendation for future research direction for PIL-IL type of FTMs is chemical modifications of the selective layer so that the carriers can be covalently bonded in order to achieve both the superior separation performance and the durability in particular for transmembrane pressures larger than zero.

TABLE 3
FTM-BS with different compositions and loadings for vacuum
operation tests. To confirm the failure of FTMs, we
tested at least two membranes for each composition

| | PIL-IL/GO loading | | | PIL:IL | | |
|---|---|---|---|---|---|---|
| Trial | (mg) | | | (molar | | |
| # | PIL | IL | GO | ratio) | Remarks | |
| 1 | 0.2 | 20 | 0.2 | 1:100 | ii in Table 1 | Leak |
| 2 | 10 | 10 | | 50:50 | — | |
| 3 | 20 | 0 | | 100:0 | — | Leak; Cracks |
| | | | | | | observed |
| 4 | 0.4 | 40 | 0.4 | 1:100 | iii in Table 1 | Leak |
| 5 | 0.2 | 20 | 0.5 | 1:100 | — | Leak |
| 6 | 0.5 | 50 | | | iv in Table 1 | |
| 7 | 10 | 10 | | 50:50 | — | |
| 8 | 50 | 50 | | | | |
| 9 | 50 | 0 | | 100:0 | — | Leak; Cracks |
| | | | | | | observed |
| 10 | 0.2 | 20 | 0.8 | 1:100 | — | Leak |
| 11 | 0.8 | 80 | | | — | |
| 12 | 10 | 10 | | 50:50 | — | |
| 13 | 40 | 40 | | | — | |
| 14 | 80 | 0 | | 100:0 | — | Leak; Cracks |
| | | | | | | observed |
| 15 | 1.25 | 3.75 | | 25:75 | — | Leak |
| 16 | 0.2 | 20 | 1 | 1:100 | — | Leak |
| 17 | 2.5 | 2.5 | | 50:50 | — | |
| 18 | 10 | 10 | | | — | No CO |
| 19 | 50 | 50 | | | — | Permeance 2 |
| 20 | 100 | 0 | | 100:0 | — | Leak; Cracks |
| | | | | | | observed |
| 21 | 1.25 | 3.75 | | 25:75 | v in Table 1 | Result in |
| | | | | | | FIG. 8a |

An FTM with PIL-IL/GO selective layer was fabricated using a highly permeable bicontinuous structured bPES/PET substrate. The nanoconfinement of PIL-IL within the GONF layer through ionic interactions between the carriers and the GO flakes and 71-71 interactions between the aromatic moieties was effective in maintaining the membrane stability under zero transmembrane pressure. The presence of O₂ in the feed did not affect the carrier-CO₂ binding capacity under the tested conditions, however it resulted in slightly slower CO₂ transport. The fabricated FTM with PIL-IL/GO selective layer and the bPES/PET substrate presented a CO₂ permeance of 2100 GPU and high selectivities of CO₂/N₂ (1100) and CO₂/O₂ (265) under conditions relevant to DAC (410 ppm CO₂, 40% RH, 295 K). Under 2500 ppm of CO₂, conditions relevant to cabin air, the permeance decreases to 430 GPU while the CO₂/N₂ selectivity and CO₂/O₂ selectivity dropped to 150 and 67, respectively. These results demonstrate a superior performance, especially the CO₂/O₂ selectivity, among the known FTMs reported to date. Further, this study represents the first FTM for CO₂ separation from air. To improve the membrane stability and to prevent leaching of the carrier for operations under a positive transmembrane pressure, the selective layer thickness was increased. The thicker membranes presented significant resistance thus resulting in lower separation performance. In order to further tune the membrane stability without increasing the thickness and resistance, covalent interactions between the PIL-IL and GO within a thin selective layer are determined to be necessary.

### The Impact of Temperature on FTM Performance

The transport of CO₂ across FTM consists of three consecutive steps:
(1) CO₂ binding: CO₂ absorption from gas to the carrier on the membrane surface
(2) CO₂ transport: CO₂ (and IL-CO₂ complex transport) via the three pathways (vehicular motion, hopping, and diffusion)
(3) CO₂ desorbing: CO₂ dissociation from the IL-CO₂ complex

The rate determining step (RDS) of our FTM is (2), which means (1) and (3) are all faster. Therefore, when temperature increase, the net transported CO₂ across membrane (CO₂ permeance) will decrease only if the reduction of (1) CO₂ binding is so profound to a point that there is not enough CO₂ to be supplied to step (2).

That being said, increasing temperature (to a point) in FTM will result in increase in CO₂ permeance; and only when the temperature reaches and passes over certain threshold, where (1) the formation of IL-CO₂ complex is really unfavored and insufficient in quantity, then we will start to observe a decrease in CO₂ permeance.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

1. A method of regenerating an ionic CO₂ capture material saturated with CO₂, the method comprising:
applying an electromagnetic field to the ionic CO₂ capture material at a frequency and intensity effective for dielectric heating of the ionic CO₂ capture material and desorption of captured CO₂.

2. The method of claim 1, wherein the CO₂ capture material comprises at least one of ionic liquid, deep eutectic solvent, or nano organic hybrid material.

3. The method of claim 1, wherein the ionic CO₂ capture material is dielectrically heated to a temperature effective to the desorb CO₂ without causing degradation of the CO₂ capture material.

4. The method of claim 1, wherein the CO₂ capture material comprises an imidazolium and/or pyrrole based ionic liquid.

5. The method of claim 1, wherein the electromagnetic field comprises microwave wave or radio frequency energy applied to the CO₂ capture material at an intensity of up to about 60 watts and a frequency from about 100 kHz to about 2.45 GHz.

6. The method of claim 1, wherein the electromagnetic field is applied to the ionic CO₂ capture material in atmosphere substantially devoid of CO₂ and at less than about 20%, less than about 10%, less than about 5%, or less that about 1% relative humidity.

7. The method of any of claim 1, wherein the CO₂ capture material includes a facilitated transport membrane that includes an ionic liquid.

8. The method of claim 7, wherein the facilitated transport membrane includes a thin film composite membrane embedded with a functionalized ionic liquid and poly(ionic liquid).

9. A system for regenerating a direct air capture (DAC) material saturated with CO₂, the system comprising:
a device for applying an electromagnetic field to a direct capture material at a frequency and intensity effective for dielectric heating of the DAC material and desorption of captured CO₂, wherein the DAC material includes at least one of an ionic liquid, deep eutectic solvent, or nano organic hybrid material.

10. The system of claim 9, wherein the DAC material is configured to be dielectrically heated to a temperature effective to the desorb CO₂ without causing degradation of the DAC.

11. The system of claim 9, wherein the DAC material comprises an imidazolium and/or pyrrole based ionic liquid.

12. The system of claim 9, wherein the DAC material comprises an imidazolium cyanopyrrolide ionic liquid.

13. The system of claim 9, wherein the device comprises a microwave wave or radiofrequency emitter configured to apply electromagnetic energy at an intensity of up to about 60 watts and at a frequency from about 100 kHz to about 2.45 GHz.

14. The system of claim 9, further including a chamber in which the DAC material is disposed for application of the electromagnetic field, the chamber having an atmosphere substantially devoid of CO₂ and less than about 20% relative humidity during application of the electromagnetic field.

15. The system of claim 9, wherein the CO₂ capture material includes a facilitated transport membrane that includes an ionic liquid.

16. A facilitated transport membrane for CO₂ capture comprising:
a graphite reinforced permeable bicontinuous structured poly(ethersulfone/poly(ethylene terephthalate) substrate embedded with a mixture of a functionalized ionic liquid and poly(ionic liquid).

17. The membrane of claim 16, wherein the functionalized ionic liquid comprises an imidazolium and/or pyrrole based ionic liquid.

18. The membrane of claim 16, wherein the poly(ionic liquid) comprises polydiallyldimethylammonium cyanopyrrolide.

19. The membrane of claim 16, wherein the substrate has a CO₂ permeance of at least about 100,000 GPU.

20. The membrane of claim 16, wherein the substrate has a PES skin layer with an interconnected pore structure having a pore size of about 20 nm to about 50 nm.
